(19) United States
(12) Patent Application Publication
(10) Pub. No.: US 2017/0340993 A1
(43) Pub. Date: Nov. 30, 2017

(54) REUSABLE FILTER SYSTEM

(71) Applicant: Hong Kong Ecoaqua Co., Limited, HONGKONG (CN)

(72) Inventor: ZOU ZHIBIN, JIMO (CN)

(73) Assignee: Hong Kong Ecoaqua Co., Limited

(21) Appl. No.: 15/194,441

(22) Filed: Jun. 27, 2016

Related U.S. Application Data
(63) Continuation-in-part of application No. 15/166,231, filed on May 26, 2016.

(51) Int. Cl. B01D 29/96; B01D 29/90; B01D 35/30

(52) U.S. Cl. CPC B01D 29/96; B01D 35/306; B01D 29/90; B01D 2201/302; B01D 2201/16; B01D 2201/304; B01D 2201/4092; B01D 2201/24

(57) ABSTRACT

A reusable fluid filter system is disclosed. The fluid filter system includes a reusable fluid filter unit that encloses a filter and is removably connected to a manifold. In an embodiment, the filter unit includes an end cap that is detachable so as to replace the filter inside the filter unit. In an embodiment, the filter unit removably engages a valve in the manifold that controls flow paths in the manifold.

### CROSS-REFERENCE TO RELATED APPLICATIONS

This application is a continuation-in-part of U.S. patent application Ser. No. 15/166,231 (Docket Number CO-1), entitled “Reusable Filter System,” by Zhibin Zou, filed May 26, 2016, which is incorporated herein by reference.

### FIELD

This specification relates generally to the purification of fluid.

### BACKGROUND

The subject matter discussed in the background section should not be assumed to be prior art merely as a result of its mention in the background section. Similarly, a problem and the understanding of the causes of a problem mentioned in the background section or associated with the subject matter of the background section should not be assumed to have been previously recognized in the prior art. The subject matter in the background section may merely represent different approaches, which in and of themselves may also be inventions.

Fluid filter systems remove impurities from fluids, such as water, so as to fulfill various requirements (e.g., for drinking purpose, medical use, industrial use, etc.). This specification recognizes the need for replacing filters in filter cartridges.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1A shows a diagram of an embodiment of a fluid filter system;

FIG. 1B shows a diagram of an embodiment of the fluid filter system of FIG. 1A with the filter unit detached from the manifold;

FIG. 2 shows an exploded view of an embodiment of the fluid filter system;

FIG. 3A shows a side view of an embodiment of the filter housing of the fluid filter system;

FIG. 3B shows a top view of an embodiment of the filter housing of the fluid filter system;

FIG. 3C shows a bottom view of an embodiment of the filter housing of the fluid filter system;

FIG. 3D shows another side view of an embodiment of the filter housing of the fluid filter system;

FIG. 4A shows a side view of an embodiment of the filter cap of the fluid filter system;

FIG. 4B shows a top view of an embodiment of the filter cap of the fluid filter system;

FIG. 4C shows a bottom view of an embodiment of the filter cap of the fluid filter system;

FIG. 5A shows a side view of an embodiment of the filter base of the fluid filter system;

FIG. 5B shows a top view of an embodiment of the filter base of the fluid filter system;

FIG. 6A shows a side view of an embodiment of the end cap of the fluid filter system;

FIG. 6B shows a bottom view of an embodiment of the end cap;

FIG. 6C shows another view of an embodiment of the end cap;

FIG. 6D shows a top view of an embodiment of the end cap;

FIG. 7A shows a cross-sectional side view of an embodiment of the filter unit of the fluid filter system;

FIG. 7B shows another cross-sectional side view of an embodiment of the filter unit of FIG. 7A;

FIG. 8A shows a cross-sectional side view of an embodiment of the manifold of the fluid filter system;

FIG. 8B shows another cross-sectional side view of an embodiment of the manifold of FIG. 8A;

FIG. 8C shows a side view of an embodiment of the manifold housing;

FIG. 8D shows a top view of an embodiment of the manifold housing;

FIG. 8E shows a bottom view of an embodiment of the manifold housing;

FIG. 8F shows a front view of an embodiment of the valve;

FIG. 8G shows a side view of an embodiment of the valve;

FIG. 8H shows a back view of an embodiment of the valve;

FIG. 8I shows a top view of an embodiment of the valve;

FIG. 8J shows a bottom view of an embodiment of the valve;

FIG. 8K shows a side view of an embodiment of the supporting member;

FIG. 8L shows a top view of an embodiment of the supporting member;

FIG. 8M shows a bottom view of an embodiment of the supporting member;

FIG. 9A shows a cross-sectional side view of an embodiment of the fluid filter system;

FIG. 9B shows another cross-sectional side view of an embodiment of the fluid filter system of FIG. 9A;

FIG. 10 is a flowchart of an embodiment of a method of using the fluid filter system; and

FIG. 11 is a flowchart of an embodiment of a method of making the fluid filter system.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

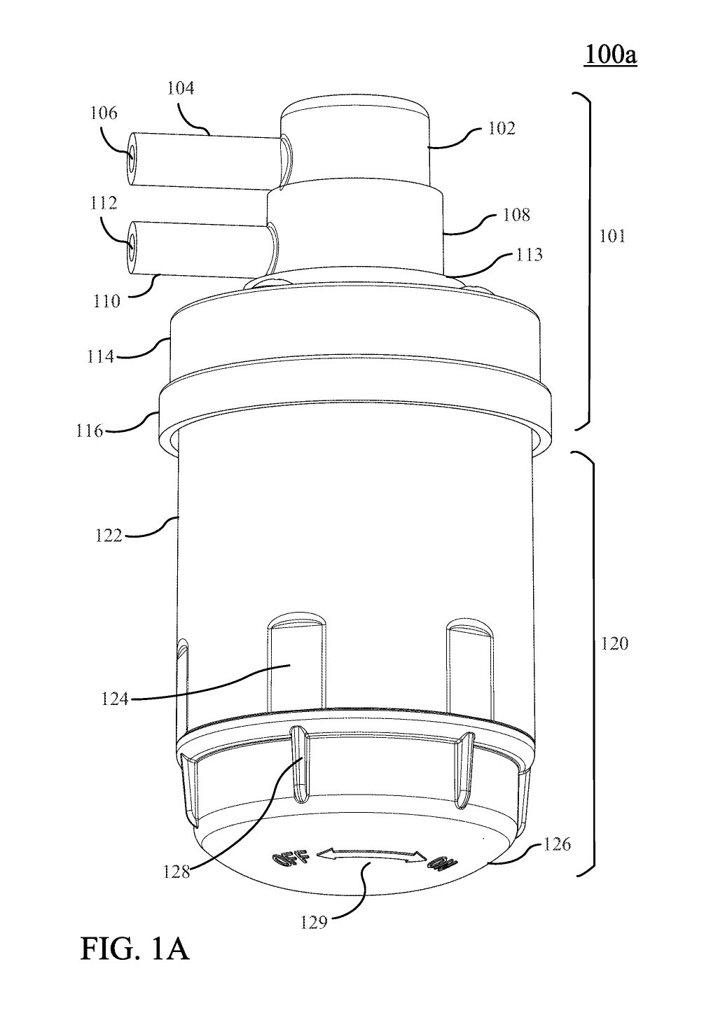

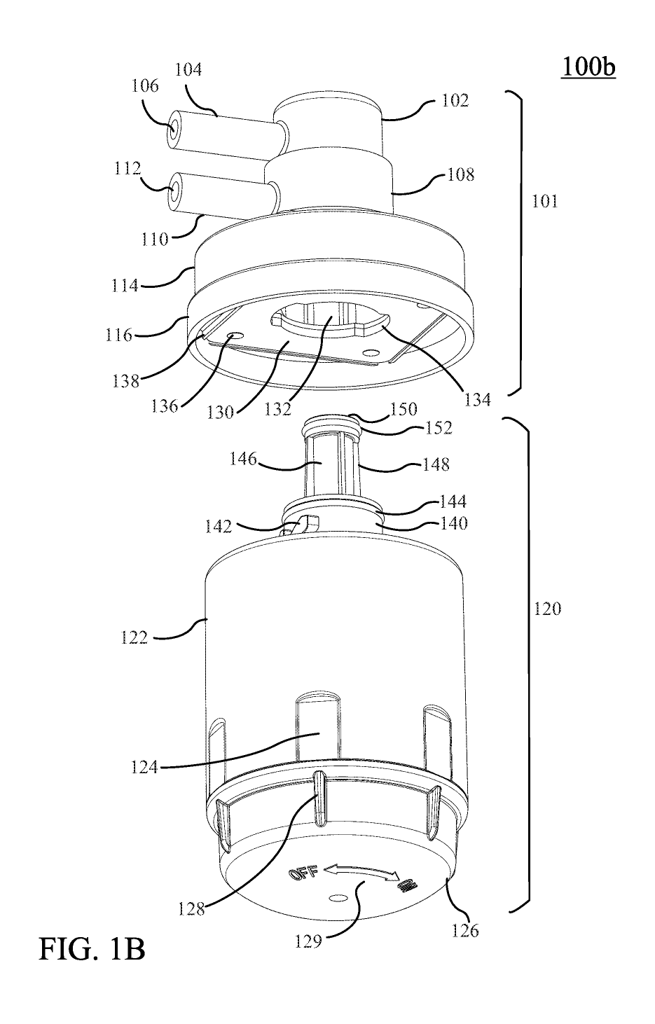

In general, at the beginning of the discussion of each of FIGS. 1A-9B is a brief description of each element. After the brief description of each element, each element is further discussed, usually in numerical order, but there is no one location where all of the information of any element of FIGS. 1A-9B is necessarily located. Unique information about any particular element or any other aspect of any of FIGS. 1A-11 may be found in, or implied by, any part of the specification.

FIG. 1A shows a diagram of an embodiment of a fluid filter system 100a. The fluid filter system 100a includes at least a manifold 101, an outlet portion 102, an outlet port 104, an outlet channel 106, an inlet portion 108, an inlet port 110, an inlet channel 112, a raised portion 113, a bottom portion 114, a base 116, a filter unit 120, a filter housing 122, indentations 124, an end cap 126, tabs 128, and markings 129. In other embodiments, the fluid filter system 100a may not include all of the components listed and/or may include other components in addition to or instead of those listed above.

In at least one embodiment, the fluid filter system 100a includes a removable filter unit/cartridge, which has a removable filter within. In this specification, the terms “removable,” “removably,” “detachably,” and “detachable” refer to being easily removable by hand (e.g., without tools). In this specification, the terms “water” and “fluid” may be interchanged with one another to obtain different embodiments. In this specification, the term “fluids” may include any type of liquids that may be filtered by the filter system 100a. The removable filter unit of the fluid filter system 100a is removably connected to a manifold. Unfiltered fluid runs through an inlet port of the manifold, and is then directed to the inside of the filter unit, where the fluid is filtered. The filtered fluid is subsequently directed out of an outlet port of the manifold and sent to the point where the fluid is used. A detachable end cap is connected to the filter unit, which can be detached so that the filter inside the filter unit can be replaced. In this specification, the side of the manifold facing away from the filter unit is referred as the top side of the fluid filter system 100a, while the end of the filter unit away from the manifold is referred to as the bottom side of the fluid filter system 100a. In this specification, the terms “filter,” “filter media,” and “filter element” may be interchanged with one another to obtain different embodiments. In this specification, the terms “filter system,” “filter cartridge,” “filter unit,” and “filter” may be interchanged with one another to obtain different embodiments. In this specification, the terms “filter unit” and “body” (e.g., the body of fluid filter system 100a) may be used interchangeably and may be substituted one for another to obtain other embodiments.

Manifold 101 is a manifold structure that includes an inlet port for receiving unfiltered fluid from a fluid source/supply and an outlet port for transporting filtered fluid out of the fluid filter system 100a. In at least one embodiment, the manifold 101 interfaces with the filter unit of the fluid filter system 100a that encloses a filter. The manifold 101 includes molded channels to direct incoming unfiltered fluid to the filter unit while allowing filtered fluid to be transported out of the fluid filter system 100a. In at least one embodiment, the manifold 101 includes at least one mechanically driven valve that is used to control the opening and closing of the channels in the manifold 101.

Outlet portion 102 is a portion of the manifold 101 that is connected to an outlet port for outputting filtered fluid. In an embodiment, the outlet portion 102 is the top portion of the manifold 101. In an embodiment, the outlet portion 102 has a circular cross section. In alternative embodiments, the outlet portion 102 may be located elsewhere, such as the top of the manifold 101, and/or have a cross section of another shape, such as square, rectangular, polygonal, triangular, ellipsoidal, or have an oval shape.

Outlet port 104 includes a conduit, which may have a tubular structure having an outlet channel that may be connected to an outlet tubing that transports filtered fluid out of the fluid filter system 100a to the point of use.

Outlet channel 106 is a channel in the outlet port 104 that directs the filtered fluid out of the manifold 101. In an embodiment, the outlet channel 106 has a circular cross section. Outlet channel 106, as well as any of the channels of this specification, may have any cross sectional shapes as outlet portion 102. Outlet portion 102 and outlet channel 106 may have the same or different cross sectional shapes.

Inlet portion 108 is a portion of the housing of the manifold 101 that is connected to an inlet port for receiving input of unfiltered/untreated fluid. In an embodiment, the inlet portion 108 is at the bottom of the outlet portion 102 and has a greater diameter than the outlet portion 102. However, in other embodiments, outlet portion 102 may be at the bottom of inlet portion 108 and/or have a greater diameter.

Inlet port 110 includes a conduit that may have a tubular structure having an inlet channel that may be connected to a fluid source/supply for receiving a flow of unfiltered fluid. In an embodiment, the outlet port 104 and inlet port 110 face the same direction. In another embodiment, the outlet port 104 and inlet port 110 may face different directions. In an embodiment, the inlet port 110 is connected to the inlet portion 108 of the manifold 101, while the outlet port 104 is connected to the outlet portion 102 of the manifold 101. In an embodiment, the inlet portion 108 and the outlet portion 102 are different parts of the manifold 101. In an embodiment, the inlet portion 108 is concentric to the outlet portion 102.

Inlet channel 112 is a channel in the inlet port 110 that directs the unfiltered fluid into the manifold 101. Although in FIG. 1A, inlet port 110 and inlet channel 112 are depicted as having the same cross sectional shape, in other embodiments, inlet port 110 and inlet channel 112 may have different cross sectional shapes. Although in FIG. 1A, outlet port 104 and inlet port 110 face the same direction, in other embodiments, outlet port 104 and inlet port 110 may face in different directions.

Raised portion 113 is a portion that extends from the top of a bottom portion of the manifold 101. In an embodiment, the inlet portion 108 extends from the raised portion 113. In an embodiment, the raised portion 113 has a diameter that is greater than the inlet portion 108. Raised portion 113 is optional.

Bottom portion 114 is a portion at the bottom of the manifold 101. In an embodiment, the bottom portion 114 has a diameter that is greater than the raised portion 113.

Base 116 is a structure, which may be referred to as a supporting member, which is connected to the bottom of, serving as a base for, the bottom portion 114 and supports the manifold 101. In at least one embodiment, the base 116 is securely fastened to the housing of the manifold 101 via screws and/or other fasteners. In at least one embodiment, the base 116 is connected to the top of the filter unit of the fluid filter system 100a.

Filter unit 120 is a portion of the fluid filter system 100a that encloses the filter. Filter unit 120 may be a removable filter cartridge that has a removable end cap, via which the filter inside the filter unit 120 maybe replaced. In at least one embodiment, the filter unit 120 includes channels/spaces that are coupled to the inlet and outlet channels of the manifold 101 to form a fluid-tight container (e.g., a watertight container and/or hermetically sealed container), while sending fluids from inlet port 110 through the filter and back to outlet port 104, during use of the fluid filter system 100a. The filter unit 120 receives unfiltered fluid, via the inlet channel 112 of the manifold 101, filters the fluid, and then directs the filtered fluid through the outlet channel 106 of the manifold 101 and then directs the filtered fluid out of the fluid filter system 100a. In this specification, the term “seal” and its conjugations refer to creating a seal that prevents fluids from leaking.

Filter housing 122 is a housing that is connected to a detachable end cap to form a container of the filter unit 120 for holding the filter media/filter element. In at least one embodiment, the top of the filter housing 122 is connected to, and sealed to (so as to prevent fluid leaks), the manifold 101, while the bottom end of the filter housing 122 is sealed by the end cap while in use.

Indentations 124 are optional and may be a plurality of grooves around the outside perimeter of the filter housing 122, which form a grip. In an embodiment, the indentations 124 extend from the bottom edge of the filter housing 122 toward the manifold 101. The indentations 124 facilitate grasping and/or gripping the filter unit 120 and/or for decoration purposes. In the embodiment in FIG. 1A, indentations 124 have a cross sectional shape that is section of a circle (e.g., an eighth of a circle) and optionally has a partly spherical top end. Indentations 124, if present, may have any of a number of shapes, such as having a cross section that is elliptical, ovular, rectangular, triangular, and/or polygonal. Similarly, the perimeter of the filter housing 122 may include protrusions in addition to, or instead of, indentations 124.

End cap 126 is an end cap that is removably attached to the bottom of the filter housing 122. In at least one embodiment, the end cap 126 is detachable (e.g., by being screwed or snapped on and off) from the filter housing 122 so that the filter inside the filter unit 120 may be replaced without replacing the entire filter unit 120, so that filter unit 120 may be used as a replaceable filter cartridge that also has a replaceable filter. As a result of filter unit 120 being replaceable while also having a replaceable filter, the user may choose to replace filter unit 120 (which may be referred to as the filter cartridge) significantly less frequently than the filter inside the filter unit 120.

Tabs 128 are a plurality of outwardly directed protrusions extending from the peripheral of the end cap 126. In an embodiment, tabs 128 are parallel to the longitudinal axis of the filter unit 120. In at least one embodiment, tabs 128 provide a better grip when a user rotates the end cap 126. In an embodiment, tabs 128 are symmetrically distributed around the peripheral of the end cap 126. Alternatively, the distribution of tabs 128 is asymmetrical. The sizes, shapes, and/or numbers of tabs 128 may vary among different embodiments. Similarly, the perimeter of the end cap 126 may include indentations in addition to or instead of tabs 128. Tabs 128 are optional. Markings 129 are also optional, and may include markings molded or printed on the bottom side of the end cap 126. In an embodiment, markings 129 may include instructions and/or arrows (and/or other pictorial indications) showing the directions to rotate the end cap 126, so as to detach and tighten up the end cap 126. For example, markings 129 may include an arrow having a first head pointing to an “ON” sign to show the rotation direction to tighten up the end cap 126 to the filter housing 122, and/or a second head pointing to an “OFF” sign to show the rotation direction to detach the end cap 126 from the filter housing 122. In another embodiment, markings 129 may include a first arrow pointing to an “ON” sign to show the rotation direction to tighten up the end cap 126 to the filter housing 122, and/or a second arrow pointing to an “OFF” sign to show the rotation direction to detach the end cap 126 from the filter housing 122.

FIG. 1B shows a diagram of an embodiment of the fluid filter system 100a of FIG. 1A with the filter unit 120 detached from the manifold 101. The embodiment of fluid filter system 100a shown in FIG. 1B includes at least the manifold 101, outlet portion 102, outlet port 104, outlet channel 106, inlet portion 108, inlet port 110, inlet channel 112, bottom portion 114, base 116, filter unit 120, filter housing 122, indentations 124, end cap 126, tabs 128, and markings 129. The system 100b further includes at least a plate 130, an opening 132, recessed areas 134, screw holes 136, tabs 138, a neck 140, tabs 142, an o-ring 144, an outlet conduit 146, fins 148, a top member 150, and an o-ring 152. In other embodiments, the embodiment shown in the view 100b may not include all of the components listed and/or may include other components in addition to or instead of those listed above.

FIG. 1B shows a view of an embodiment of the fluid filter system 100a with the filter unit 120 detached from the manifold 101. The manifold 101, outlet portion 102, outlet port 104, outlet channel 106, inlet portion 108, inlet port 110, inlet channel 112, bottom portion 114, base 116, filter unit 120, filter housing 122, indentations 124, end cap 126, tabs 128, and markings 129 were discussed above in conjunction with FIG. 1A.

Plate 130 is a plate that attaches to the bottom part of the base 116. Although in the embodiment of FIG. 1B, plate 130 is square, in other embodiments, plate 130 may have other shapes, such as rectangular, ovular, ellipsoidal, triangular, polygonal, or another shape. Although in the embodiment of FIG. 1B, plate 130 and base 116 are separate pieces fastened together by fasteners (such as screws), in another embodiment, plate 130 and base 116 may be one integral piece of material.

Opening 132 is an opening in the center of the plate 130 for receiving a neck portion of the filter unit 120.

Recessed areas 134 are two side indents at either side of the opening 132, facing each other. In at least one embodiment, the recessed areas 134 allow two tabs extending from the neck portion of the filter unit 120 to be inserted through.

Screw holes 136 are four screw holes at corners of the plate 130 for receiving screws that fasten the housing of the manifold 101 to the base 116 and plate 130. In an embodiment, the plate 130 may include other numbers of screw holes in alternative embodiments. Alternatively or additionally, the housing of the manifold 101 and the base 116 may be fastened using other types of fasteners, such as rivets, pegs, buckles, buttons, or snaps.

Tabs 138 are four linear tabs extending downwardly from the bottom side of the base 116 for holding the plate 130 in place. In at least one embodiment, the tabs 138 form a square cavity into which the plate 130 is fitted.

Neck 140 protrudes from the top of the filter housing 122. In at least one embodiment, the neck 140 engages with the inlet portion 108 of the manifold 101 and forms a fluid tight connection with the manifold 101.

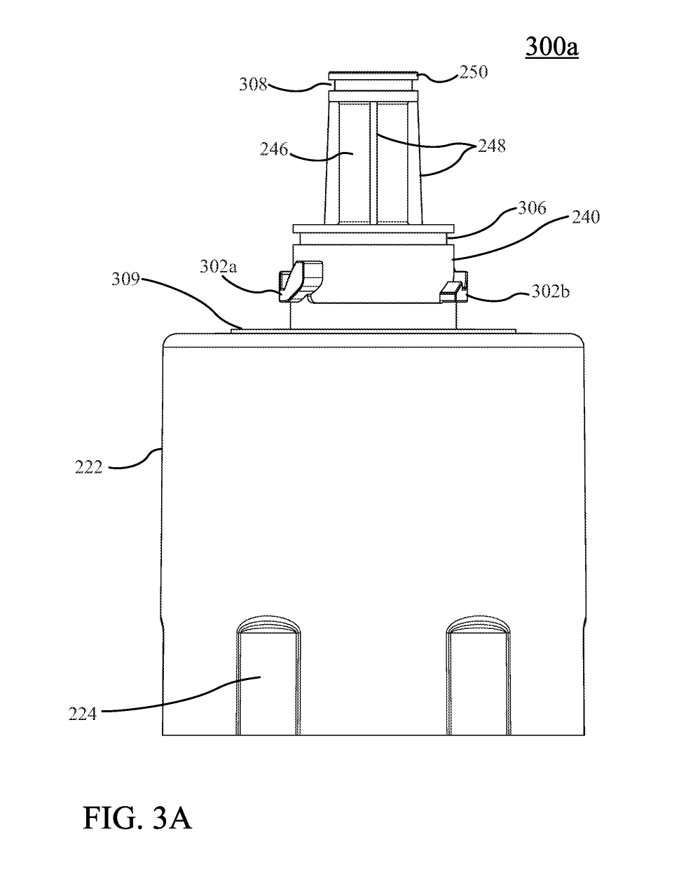

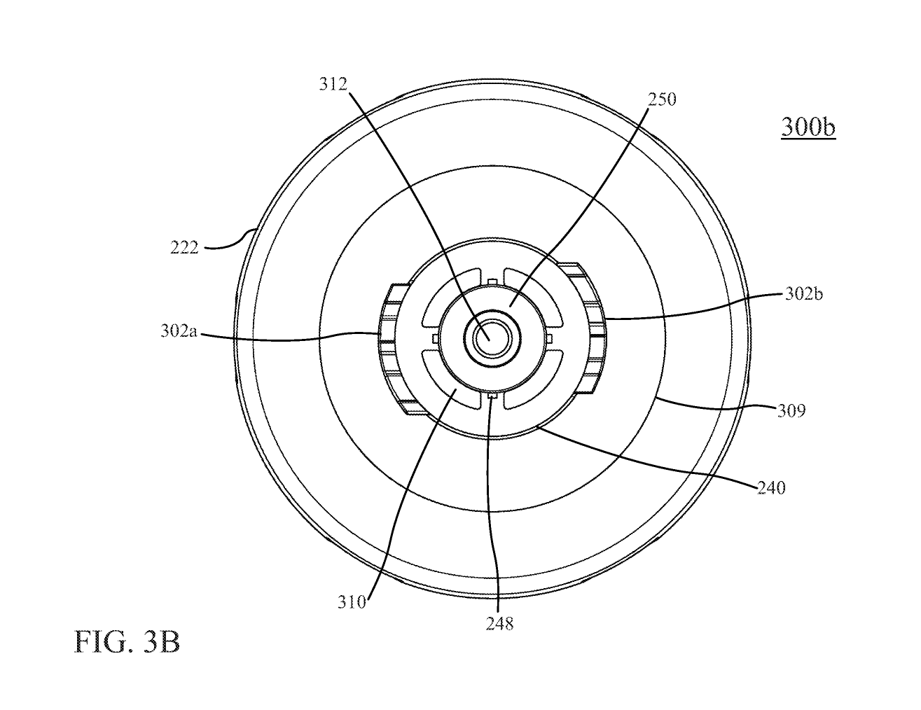

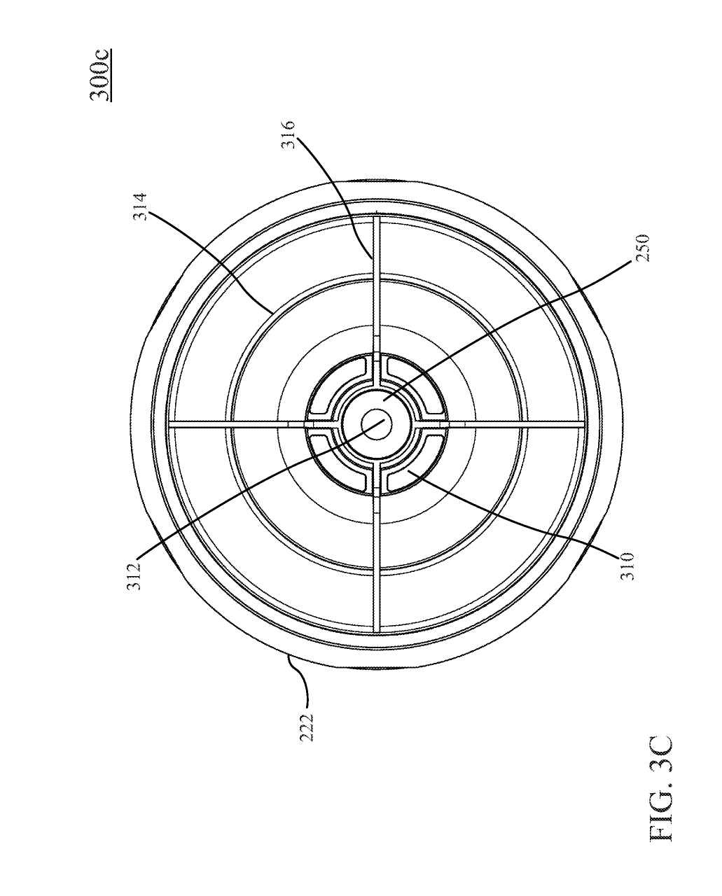

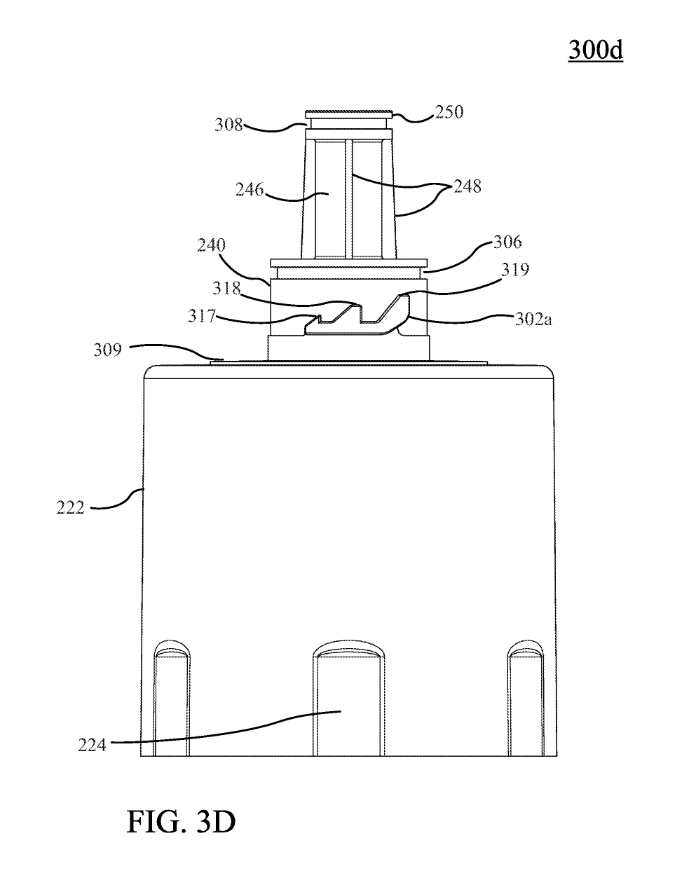

Tabs 142 are two sets of diametrically opposed tabs that project radially outwardly from the outside circumferential margin of the neck 140. Although FIG. 1B depicts one set of tabs 142, the filter unit 120 may include another set of tabs extending from the neck 140, which is diametrically opposed to the set of tabs visible in FIG. 1B. In an embodiment, each set of tabs 142 may be replaced with a single tab. In at least one embodiment, the tabs 142 are dimensioned so as to allow the neck 140 to be inserted through the opening 132 and engage the manifold 101. The tabs 142 will be discussed in further detail in FIGS. 3A-3D.

O-ring 144 is a circular loop of elastomer fitted on the neck 140 for providing a fluid-tight seal when the neck 140 is inserted into the inlet portion 108 of the manifold 101. The seal between the neck 140 and the inlet portion 108 prevents the unfiltered fluid entering the filter unit from leaking around the neck 140. In one embodiment, the o-ring 144 and/or any other o-rings in this specification is made of rubber, silicone, or any other soft and/or resilient fluid tight materials. In an embodiment any of the O-rings of this specification may be made from any gummy, rubbery material, elastomer, nonporous, and/or flexible material that prevents fluids from leaking. Some nonlimiting examples of materials that may be used for the O-rings are natural rubber, polyacrylate rubber, ethylene-acrylate rubber, polyester urethane, bromo isobutylene isoprene bromobutyl, polybutadiene buna, chloro isobutylene isoprene chlorobutyl, buty polychloroprene chloroprene, neoprene, chlorosulphonated polyethylene hypalon, epichlorohydrin, epichlorohydrin, epichlore, epichloridrine, herclor, hydrin, ethylene propylene, ethylene propylene diene monomer, nordel, polyether urethane, perfluorocarbon rubber, kalrez, chemraz, fluoronated hydrocarbon viton, fluorel, fluoro silicone, silicone rubber, fluorocarbon rubber, hydrogenated nitrile butadiene, polyisoprene (synthetic) natural rubber, isobutylene isoprene butyl butyl, acrylonitrile butadiene, nitrile, perbunan, buna-N, polyurethane, polyurethane, styrene butadiene, buna-S, GRS, buna VSL, buna SE, styrene ethylene butylene styrene copolymer rubber, polysiloxane silicone rubber, vinyl methyl silicone, silicone rubber, acrylonitrile butadiene carboxy monomer, carboxylated nitrile, styrene butadiene carboxy monomer, thermoplastic polyether-ester, styrene butadiene block copolymer, and/or styrene butadiene carboxy block copolymer. O-ring 144 as well as the other o-rings in this specification are optional and other methods of making the connection fluid-tight may be used instead, such as by placing a waxy substance on the connection that does not dissolve in the fluid. In this specification, any part that is intended to form a seal with an o-ring or another component so that fluids will not leak may be made from a nonporous material, such as plastic or metal. Some non-limiting examples of nonporous plastics that may be used for the filter cap 240 or the inner surface of top protrusion 242 and/or other components used for creating a seal are Polyethylene Terephthalate (PET), High-Density Polyethylene (HDPE), Acrylonitrile Butadiene Styrene (ABS), Polyvinyl Chloride (PVC) or Polypropylene (PP).

Outlet conduit 146 is a structure, which may be cylindrical, extending from the top surface of the neck 140. The outlet conduit 146 includes an outlet channel and an outlet opening that is connected to the outlet channel 106 in the outlet port 104 for directing filtered fluid out of the fluid filter system 100a.

Fins 148 are optional and may include a plurality of outwardly directed fins extending radially from the outer surface of the walls of the outlet conduit 146. In an embodiment, each of the fins 148 includes two side walls that extend from the outlet conduit 146 and an end wall that connects the ends of the two side walls away from the outlet conduit 146. In an embodiment, the side walls of the fins 148 align along the longitudinal axis of the outlet conduit 146. In an embodiment, the width of the side walls of the fins 148 near the top of the outlet conduit 146 are different from the width of the side walls near the bottom of the outlet conduit 146. For example, the width of the side walls of the fins near the bottom may be greater than the width of the side walls near the top. In an embodiment, fins 148 are symmetrically distributed around the peripheral of the outlet conduit 146. Alternatively, the distribution of fins 148 is asymmetrical. The sizes, shapes, and/or numbers of fins 148 may vary among different embodiments. Similarly, the perimeter of the outlet conduit 146 may include other structures in addition to or instead of fins 148.

Top member 150 is the top portion of the outlet conduit 146 that faces away from the filter housing 122. In an embodiment, the top member 150 has a cross-sectional diameter that is greater than the diameter of the outlet conduit 146. In an embodiment, the top member 150 is inserted into a valve in the manifold 101 while the top member 150 with the o-ring makes a fluid-tight seal to separate a space in the valve above the top member 150 and a space below the top member 150 (e.g., between the valve and the outlet conduit 146).

O-ring 152 is a circular loop, which may be made from an elastomer, fitted on the top member 150 for providing a fluid-tight seal when the top member 150 is inserted into the outlet portion 102 of the manifold 101. The seal between the top member 150 and the outlet portion 102 prevents the filtered fluid running out of the outlet conduit 146 from leaking around the top member 150.

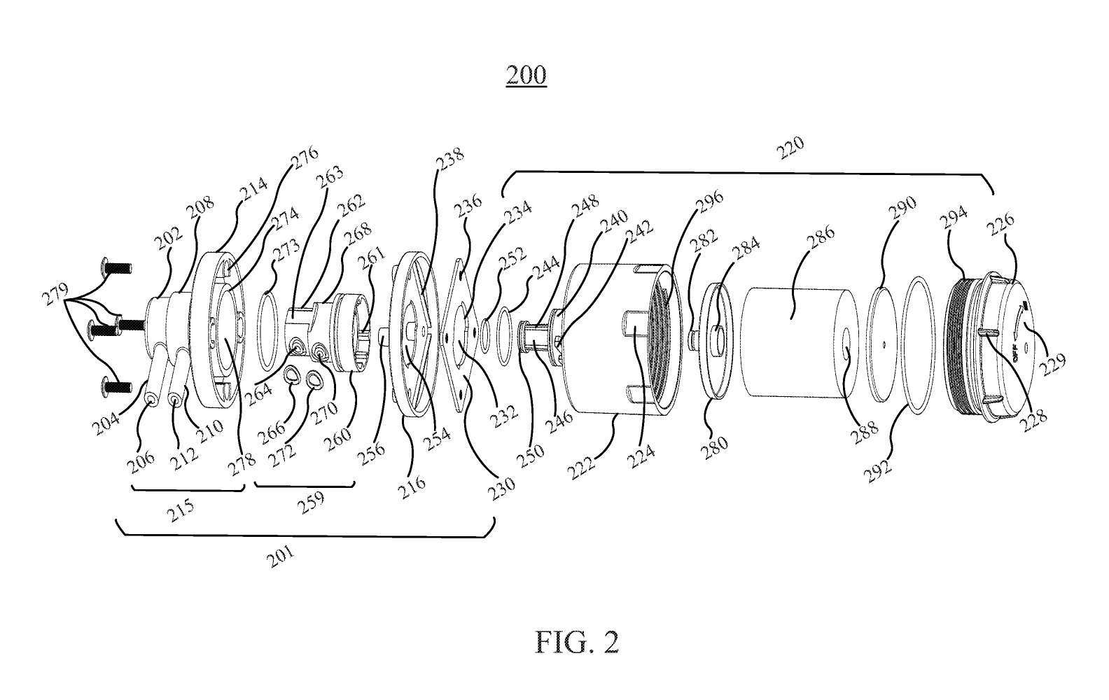

FIG. 2 shows an exploded view of an embodiment of the fluid filter system 200. The fluid filter system 200 includes at least a manifold 201, an outlet portion 202, an outlet port 204, an outlet channel 206, an inlet portion 208, an inlet port 210, an inlet channel 212, a bottom portion 214, a manifold housing 215, a base 216, a filter unit 220, a filter housing 222, indentations 224, an end cap 226, tabs 228, markings 229, a plate 230, an opening 232, side indents 234, screw holes 236, tabs 238, a neck 240, tabs 242, an o-ring 244, an outlet conduit 246, fins 248, a top member 250, and an o-ring 252, an opening 254, posts 256, a valve 259, a valve base 260, tabs 261, an outlet portion 262, a flat portion 263, an outlet opening 264, an o-ring 266, an inlet portion 268, an inlet opening 270, an o-ring 272, an o-ring 273, bottom protrusion 274, guide members 276, an opening 278, screws 279, a filter cap 280, a top protrusion 282, a bottom protrusion 284, a filter 286, an inner channel 288, a filter base 290, an o-ring 292, threads 294, and inner threads 296. In other embodiments, the fluid filter system 200 may not include all of the components listed and/or may include other components in addition to or instead of those listed above.

FIG. 2 shows an exploded view of an embodiment of the fluid filter system 200, which may be an embodiment of the fluid filter system 100a that was discussed in conjunction with FIGS. 1A and 1B. The manifold 201, outlet portion 202, outlet port 204, outlet channel 206, inlet portion 208, inlet port 210, inlet channel 212, bottom portion 214, base 216, filter unit 220, filter housing 222, indentations 224, end cap 226, tabs 228, and markings 229 may be embodiments of the manifold 101, outlet portion 102, outlet port 104, outlet channel 106, inlet portion 108, inlet port 110, inlet channel 112, bottom portion 114, base 116, filter unit 120, filter housing 122, indentations 124, end cap 126, tabs 128, and markings 129, respectively, which were discussed in conjunction with FIG. 1A. The plate 230, opening 232, side indents 234, screw holes 236, tabs 238, neck 240, tabs 242, o-ring 244, outlet conduit 246, fins 248, top member 250, and o-ring 252 may be embodiments of the plate 130, opening 132, recessed areas 134, screw holes 136, tabs 138, neck 140, tabs 142, o-ring 144, outlet conduit 146, fins 148, top member 150, and o-ring 152, respectively, which were discussed in conjunction with FIG. 1B.

Manifold housing 215 is the housing portion of the manifold 201, which holds a valve. In an embodiment, the manifold housing 215 includes the inlet port 210 and outlet port 204 that extend on one side of the manifold housing 215 and face the same direction. Alternatively, the inlet port 210 and outlet port 204 may be located elsewhere on the manifold housing 215 and/or may face different directions. In at least one embodiment, the bottom of the manifold housing 215 is fastened to the top of the base 216 while in use.

Opening 254 is an opening in the center of the base 216, through which the neck 240 (which is on top of the filter housing 222) is inserted.

Posts 256 are four fasteners, which in an embodiment are shaped like poles, protruding from the top of the base 216. In at least one embodiment, the posts 256 include screw holes, having threads, for receiving four screws to fasten the manifold housing 215 with the supporting member 216 (in other embodiments, another fastener may be used instead of the combination of posts 256 and screws).

Valve 259 is a mechanically driven valve that controls opening and closing of flow paths of fluids through the valve 259. In an embodiment, to open the valve 259, the valve 259 is rotated to an open position where an inlet opening and an outlet opening of the valve 259 align with the inlet channel 212 and outlet channel 206 of the manifold housing 215, respectively. The valve 259 closes when the valve 259 is rotated to a closed position where the inlet opening and outlet opening of the valve 259 are disconnected from the inlet channel 212 and outlet channel 206 of the manifold housing 215, respectively. In other embodiments, valve 259 may be opened and closed in another manner.

Valve base 260 is a bottom portion of the valve 259 for supporting an outlet portion and an inlet portion of the valve 259.

Tabs 261 include a plurality of inwardly directed tabs extending from the inner circumferential surface of the valve base 260. In at least one embodiment, the tabs 261 engage the tabs 242 on the neck 240 when the fluid filter system 200 is fully assembled. In another embodiment, tabs 261 and tabs 242 may be replaced with another locking mechanism that causes the neck 240 to turn with the valve 259.

Outlet portion 262 is a portion of the valve 259 that directs filtered fluids out of the valve 259. In an embodiment, the outlet portion 262 is the top portion of the valve 259.

Flat portion 263 is a portion of the outlet portion 262 that has a flat wall.

Outlet opening 264 is an opening in the outlet portion 262 for directing filtered water out of the valve 259 into outlet channel 206.

O-ring 266 is optional, and is an o-ring that is fitted around the outlet opening 264 of the valve 259 for providing a fluid-tight seal when the valve 259 is inserted in the manifold housing 215, and at least when valve 259 is aligned in the open position. The seal around the outlet opening 264 prevents the outlet filtered fluid in the outlet portion 262 of the valve 259 from leaking out around the outlet opening 264 at least when valve 259 is in the open position.

Inlet portion 268 is a portion of the valve 259 that receives unfiltered fluid and directs the unfiltered fluid to the filter unit 220. In an embodiment, the inlet portion 268 is connected to the bottom of the outlet portion 262, and also connected to the top of the valve base 260. In an embodiment, the inlet portion 268 has a circular cross section or a cross section of another shape. In an alternative embodiment, the relative position of the outlet portion 262 and inlet portion 268 may be different from the embodiment shown in FIG. 2 (e.g., the outlet portion 262 may be at the bottom of the inlet portion 268 or the outlet portion and inlet portion 268 may be side by side).

Inlet opening 270 is an opening in the inlet portion 268 for receiving unfiltered water, from channel 212 of manifold housing 215, into the valve 259. In an embodiment, the outlet opening 264 and inlet opening 270 are on the same side of the valve 259, facing the same direction. In another embodiment, the outlet opening 264 and inlet opening 270 face different directions. In an embodiment, the outlet opening 264 and inlet opening 270 do not face opposite directions.

O-ring 272 is optional, and is an o-ring that is fitted around the inlet opening 270 of the valve 259 for providing a fluid-tight seal when the valve 259 is inserted in the manifold housing 215, and at least when valve 259 is aligned with manifold housing 215 in the open position. The seal around the inlet opening 270 prevents the incoming unfiltered fluid from leaking out around the inlet opening 270 at least when valve 259 is aligned with manifold housing 215 in the open position. In an embodiment, when the valve 259 is in the closed position, in which the inlet opening 270 and outlet opening 264 face the inner side of the walls of the inlet portion 208 and outlet portion 202, respectively, the o-rings 266 and 272 make a fluid-tight seal between the valve 259 and the inner surfaces of the walls of the inlet portion 208 and outlet portion 202, preventing fluid from entering the filter unit 220.

O-ring 273 is optional and is an o-ring that is fitted on the valve base 260 for providing a fluid-tight seal when the valve base 260 is inserted in the manifold housing 215. The seal between the valve base 260 and the manifold housing 215 prevents fluid in the manifold 201 from leaking around the valve base 260. O-rings 266, 272, and 273 may be replaced with another manner of maintaining a fluid-tight seal.

Bottom protrusion 274 may be a tubular structure that protrudes from the bottom side of the bottom portion 214 of the manifold housing 215, facing the filter unit 220. In at least one embodiment, the bottom protrusion 274 is fitted onto the valve base 260 and form a fluid-tight engagement, in combination with o-ring 273 and base 260.

Guide members 276 are protrusions, which may be tubular in shape and/or may optionally have an opening in the wall that forms guide members 276. In an embodiment, the guide members have a cross sectional shape that is section of a circle (e.g., three quarters of a circle). In at least one embodiment, the open part of each guide member faces the center of the manifold housing 215 while the opposite part of the wall connects to (e.g., is an integral part of) the inside of the rim of the bottom portion 214. Although guide members 276 of FIG. 2 each have one opening in other embodiments, there may not be an opening or there may be more openings in addition to, or instead of, those openings shown in the wall of guide members 276 of FIG. 2. Guide members 276 engage posts 256 of base 216. Although in FIG. 2 there are 4 guide members 276 and 4 posts 256, in other embodiments there may be other numbers of guide members 276 and posts 256.

Opening 278 is an opening in the bottom protrusion 274 into which the valve base 260 is fitted to form a fluid-tight seal with the aid of o-ring 273.

Screws 279 are four fasteners that affix the manifold housing of pump 215 to the supporting member 216. Each of screws 279 screws into a hole in one of the posts 256, thereby holding the manifold housing 215 to posts 256. Although FIG. 2 depicts four screws 279, other numbers of screws may be used to fasten the manifold housing 215 to the supporting member 216. In other embodiments, screws 279 could be replaced with other types of fasteners, such as buckles, buttons, or snaps to obtain a different embodiment.

Filter cap 280 is a cap that is fitted on the top of the filter. Filter cap 280 is placed at the top of the filter and holds the filter in place with respect to the filter housing 222 and to the manifold 201.

Top protrusion 282 is a tubular structure that protrudes from the top side of a dish shaped body of the filter cap 280, facing the manifold 201. In at least one embodiment, the outer diameter of the top protrusion 282 is slightly smaller than the inner diameter of the neck 240. In at least one embodiment, the top protrusion 282 is fitted in an opening at the bottom of the neck 240.

Bottom protrusion 284 is a structure, which maybe tubular, that protrudes from the bottom side of the dish shaped body of the filter cap 280, facing the filter. In at least one embodiment, the bottom protrusion 284 is an alignment structure that engages the filter to hold the filter in place or at least limit the extent to which the filter can move sideways. For example, bottom protrusion 284 may be fitted into an inner channel of the filter so as to connect the bottom protrusion 284 to the inner channel of the filter. The dish shaped body of the filter cap 280 includes a centrally located through-opening connecting the channels in the top protrusion 282 and bottom protrusion 284. The channel of top protrusion 282 and bottom protrusion 284 may be different parts of the same channel. In other embodiments, bottom protrusion 284 may be replaced by other structures, such as pins or tabs that engage the channel of the filter and/or other structures in the filter that are complementary to the alignment structures of the filter cap 280.

Filter 286 separates the chamber in which filter 286 is installed into two regions/spaces, so that filtered fluid is on one side of the wall formed by the filter 286 and unfiltered fluid is on the other side. Incoming fluids are pumped into the part of the chamber on one side of the wall formed by the filter 286, the fluids under the pressure of the incoming fluids seep through the wall of the filter 286, and then the pressure of the fluid seeping through the wall of the filter 286 pushes the fluid out of filter unit 220. In one embodiment, filter 286 includes a hollow core (e.g., an inner channel) into which fluids, under pressure from the incoming fluid, seep from outside filter 286. As the fluid seeps through the wall of filter 286, filter 286 filters the fluid that is pumped into filter unit 220. In an embodiment, fluid is pumped into filter unit 220 to a location in filter unit 220 just outside of the filter 286. After the fluid seeps from just outside filter 286, through the wall of filter 286, into the hollow core/inner channel within filter 286, the fluid from the hollow core travels, via the opening of the hollow core in the filter 286, and out of the filter 286 into outlet conduit 246. In an embodiment, filter 286 is cylindrical and opening into the hollow core and the hollow core is a cylindrical channel running through the center of the filter 286 concentric with filter 286. In an embodiment, filter 286 includes an inner channel that is open on both ends, allowing more fluid to fill the hollow core and be processed by filter 286. In other embodiments, filter 286 could have other shapes, such as rectangular square, or spherical, and/or the opening has a different shape than the rest of the hollow core. Similarly, in another embodiment, filter 286 may be open on only one end. In an embodiment, when filter unit 220 is assembled, the filter 286 is slightly compressed between the filter cap 240 and the base (or an end cap) of filter unit 220. The compression to fully install the filter 286 prevents unfiltered fluid from bypassing the filter 286 and entering the inner channel inside the filter 286. In an alternative embodiment, unfiltered fluid may be pumped to the core of the filter 286, seeps through the wall of filter 286 and then under the pressure of the fluid seeping through the wall of the filter 286 travels from the space just outside of the filter 286 out of the filter unit 220. In other embodiments, instead of the filter 286 having a hollow core, filter 286 may be a flat wall or a wall of another shape that separates two regions of the chamber in which filter 286 is installed so that filtered fluid is on one side of the wall formed by the filter and unfiltered fluid is on the other side.

Inner channel 288 is the hollow core of filter 286. In an embodiment, inner channel 288 has a circular cross section that runs throughout the length of the filter 286. In other embodiments, inner channel 288 has other cross sectional shapes, such as rectangular, ovular, elliptical, and/or triangular and may not necessarily have the same shape throughout the length of the filter 286. Fluid filtered by the filter 286 enters the inner channel 288 and is then directed through the outlet conduit 246 to the outlet port 204.

Filter base 290 is an optional plate with a rim, which is an outer edge extending upward toward the filter 286. The rim is optional and helps hold the filter 286 in place or at least limits the extent to which filter 286 may move sideways. The filter base 290 holds and supports the bottom of the filter 286 when the filter unit 220 is fully assembled. In an embodiment, the filter base 290 is fitted in a cavity inside the end cap 226. In another embodiment, filter base 290 is built into end cap 226. Filter base 290 may exert a slight pressure on filter 286, when the end cap 226 is fully closed, so that to prevent fluid from outside filter 286 from leaking into inner channel 288 without being filtered as a result of seeping through the wall of filter 286. Optionally, the filter base 290 may include with a freeze protection pad that may be made from a closed cell foam material. In an embodiment, the filter base 290 is not associated with a freeze protection pad that may be made from a closed cell foam material.

O-ring 292 is optional. O-ring 292 is a circular ring shaped like an O that is fitted on a top portion of the end cap 226 for providing a fluid-tight seal when the end cap 226 is connected (e.g., screwed on) to the filter housing 222. The seal between the end cap 226 and the filter housing 222 prevents the fluid in the filter unit 220 from leaking into the end cap 226 and/or from leaking out of filter unit 220, via the connection between end cap 226 and filter housing 222.

Threads 294 are outwardly facing threads on the external of the top portion of the end cap 226. In at least one embodiment, the threads 294 mate with corresponding threads located on the inner surface of the filter housing 222 near the bottom side for selectively securing the end cap 226 and the filter housing 222. In another embodiment, end cap 226 has inwardly facing threads, and filter housing 222 has outwardly facing threads that mate with the inwardly facing threads of end cap 226.

Inner threads 296 are inwardly facing threads located on the inner surface of the filter housing 222 near the bottom side for mating with the threads 294 on the end cap 226. In other embodiments inner threads 296 and threads 294 may be replaced with other fastening mechanisms, such as such as rivets, pegs, buckles, buttons, or snaps.

FIG. 3A shows a side view of an embodiment of the filter housing 300a of the fluid filter system. Filter housing 300a includes at least the filter housing 222, indentations 224, neck 240, outlet conduit 246, fins 248, and top member 250. Housing 300a further includes at least two sets of tabs 302a and 302b, a groove 306, a groove 308, and a bottom member 309. In other embodiments, the filter housing 300a may not include all of the components listed and/or may include other components in addition to or instead of those listed above.

FIG. 3A shows a side view of an embodiment of the filter housing 300a that may be an embodiment of the filter housing 122 or 222, which were discussed in conjunction with FIGS. 1A and 1B and FIG. 2, respectively.

Tabs 302a and tabs 302b may be embodiments of the tabs 142 or 242, which were discussed in conjunction with FIGS. 1B and 2. Tabs 302a and 302b will be discussed further in FIG. 3D.

Groove 306 is a circumferential groove formed in the neck 240 adjacent to the outlet conduit 246. In an embodiment, the groove 306 is adapted and configured for receiving, and holding in place, the o-ring 144 or 244 for preventing fluid from leaking around the neck 240.

Groove 308 is a circumferential groove formed in the top member 250. In an embodiment, the groove 308 is adapted and configured for receiving, and holding in place, the o-ring 152 or 252 for preventing fluid from leaking around the top member 250.

Bottom member 309 is a raised portion that extends from the top of the housing 222. In an embodiment, the neck 240 extends from the bottom member 309. In an embodiment, the bottom member 309 has a diameter that is greater than the neck 240. In an embodiment, the bottom member 309 provides structural strength to the filter housing 222 so that the neck 240 does not break through the top of the filter housing 222. The bottom member 309 is optional and the neck 240 may extend directly from the top of the filter housing 222.

FIG. 3B shows a top view 300b of an embodiment of the filter housing 300a of the fluid filter system. The embodiment of the filter housing 300a shown in FIG. 3B includes at least the filter housing 222, neck 240, fins 248, top member 250, tabs 302a and 302b, and bottom member 309, which were discussed in FIGS. 2 and 3A, respectively. FIG. 3B further shows at least holes 310 and an outlet opening 312. In other embodiments, the embodiment shown in the view 300b may not include all of the components listed and/or may include other components in addition to or instead of those listed above.

FIG. 3B shows a top view 300b of an embodiment of the filter housing 300a.

Holes 310 are a plurality of opening on the top surface of the neck 240, where fluids can penetrate into filter housing 300a. In at least one embodiment, the holes 310 permit incoming unfiltered fluid (e.g., the incoming fluid received via the inlet channel 112 (FIG. 1A or 1B) through the inlet opening 270 (FIG. 2)) to pass toward the filter media inside the filter unit.

Outlet opening 312 is an opening on the top of the top member 250 (FIG. 2), through which the filtered fluid in the filter unit exits the outlet conduit 246 and enters the outlet channel 106 (FIG. 1A or 1B).

FIG. 3C shows a bottom view 300c of an embodiment of the filter housing 300a of the fluid filter system. The embodiment of housing 300a shown in FIG. 3C includes at least the filter housing 222, top member 250, holes 310, outlet opening 312, which were discussed in FIGS. 2, 3A, and 3B, respectively. The embodiment of housing 300a shown in FIG. 3C further includes a wall 314, and fins 316. In other embodiments, the embodiment shown in the view 300c may not include all of the components listed and/or may include other components in addition to or instead of those listed above.

FIG. 3C shows a bottom view 300c of an embodiment of the inside of the filter housing 300a.

Wall 314 is a circular wall located inside the filter housing 222, extending downwardly from the underside of the top portion of the filter housing 222. In an embodiment, wall 314 provides structural strength to the top part of the filter housing 222. In an embodiment, the wall 314 outlines the peripheral of the underside of the bottom member 309. Although a circular wall 314 is illustrated in FIG. 3C, another shape of wall arranged in other locations may be employed in alternative embodiments.

Fins 316 are a plurality of fins located inside the filter housing 222, extending downwardly from the underside of the top portion of the filter housing 222. In at least one embodiment, the fins 316 may contact and support the filter cap 280 (FIG. 2) when the fluid filter system is fully assembled. In an embodiment, fins 316 may be curved toward the center of the filter housing providing an easier insertion for the top protrusion 282 of the filter cap 280 as compared to were the fins 316 to have the exact same contour as the top protrusion 282 of the filter cap 280. Although four fins 316, approximately 90 degrees apart from each other, are illustrated in FIG. 3C, any number of fins arranged in other locations may be employed in alternative embodiments.

FIG. 3D shows another side view 300d of an embodiment of the filter housing 300a of the fluid filter system. The embodiment of housing 300a shown in FIG. 3D includes at least the filter housing 222, indentations 224, neck 240, outlet conduit 246, fins 248, top member 250, tabs 302a, groove 306, groove 308, bottom member 309, which were discussed in FIGS. 2, 3A, 3B, and 3C, respectively. The embodiment of housing 300a shown in FIG. 3D further includes a first tooth 317, a second tooth 318, and a third tooth 319. In other embodiments, the embodiment shown in the view 300c may not include all of the components listed and/or may include other components in addition to or instead of those listed above.

FIG. 3D shows another side view 300d of an embodiment of the filter housing 300a, in which the set of tabs 302a is visible. In at least one embodiment, the tabs 302a may include a plurality of structures that resemble teeth of a key. In an embodiment, the set of tabs 302a may be molded into one piece that includes an upper surface that resembles the formation of the teeth of a key. The set of tabs 302a, as well as the set of tabs 302b, is adapted and configured to mate with a corresponding set of tabs 261 formed within the valve base 260.

First tooth 317, second tooth 318, and third tooth 319 are three spaced apart teeth facing upward. In an embodiment, a base portion is located on one side of the first tooth 317, and below the second tooth 318 and third tooth 319. In at least one embodiment, the first tooth 317, second tooth 318, and/or third tooth 319 may include ramped surfaces. In another embodiment, the first tooth 317, second tooth 318, and/or third tooth 319 may be directly connected to the base portion. In another embodiment, the first tooth 317, second tooth 318, third tooth 319, and the base portion may be molded into one piece. In at least one embodiment, the valve base 260 includes recessed areas formed between the tabs 261 that accommodate the first tooth 317, second tooth 318, and third tooth 319 so as to engage the filter unit 220 with the valve 259. Although FIG. 3D depicts three teeth included in the set of the tabs 302a, other numbers of teeth having other shapes may be used to mate with corresponding recess areas in the valve base in alternative embodiments.

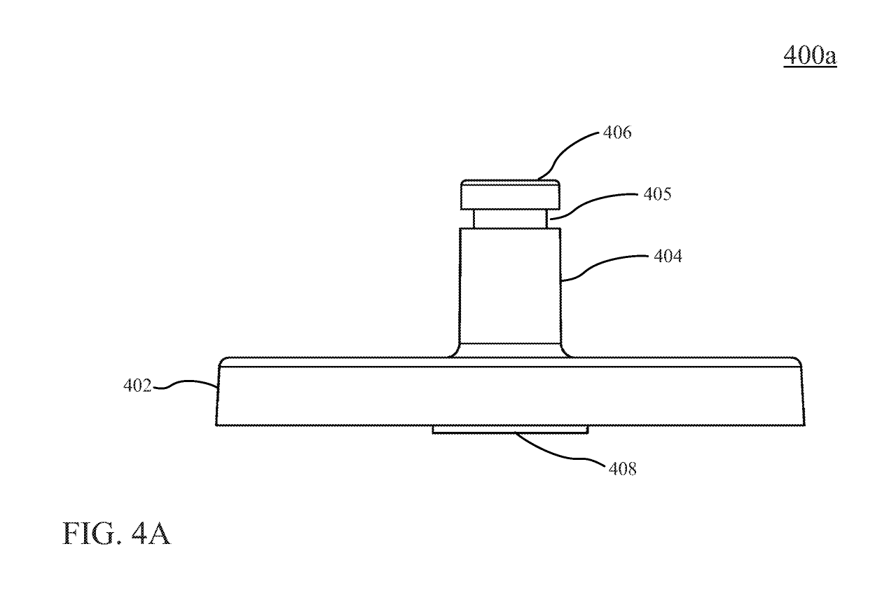

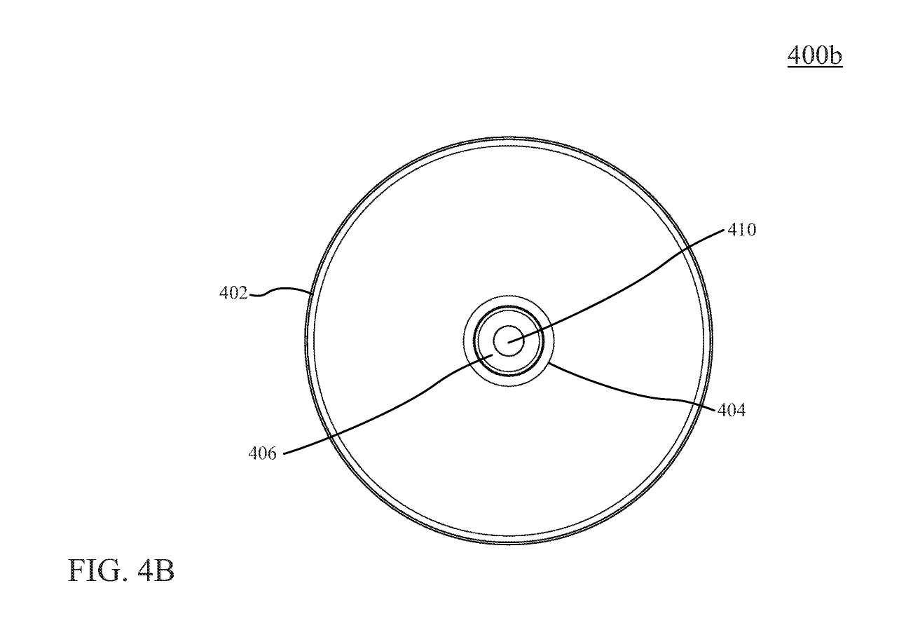

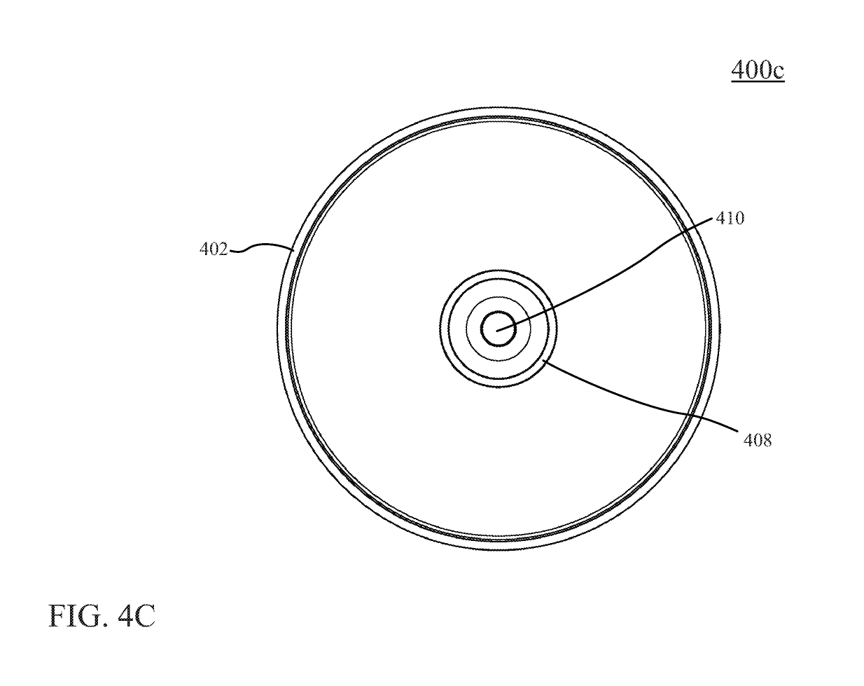

FIG. 4A shows a side view of an embodiment of the filter cap 400a of the fluid filter system. Filter cap 400a includes at least a dish 402, a top protrusion 404, a groove 405, a top surface 406, and a bottom protrusion 408. In other embodiments, the filter cap 400a may not include all of the components listed and/or may include other components in addition to or instead of those listed above.

FIG. 4A shows a side view of an embodiment of the filter cap 400a. Filter cap 400a, top protrusion 404, and bottom protrusion 408 may be embodiments of the filter cap 280, top protrusion 282, and bottom protrusion 284, respectively, which were discussed in conjunction with FIG. 2.

Dish 402 is a dish shaped structure of the filter cap 400a that is fitted on the top of the filter 286. In an embodiment, the dish 402 includes a rim having an outer edge extending downwardly for holding the filter 286 in place.

Groove 405 is a circumferential groove formed in the top protrusion 404 adjacent to the top surface. In an embodiment, the groove 405 is adapted and configured for receiving an o-ring for preventing fluid from leaking around the top protrusion 404.

Top surface 406 is the top surface of the top protrusion 404, facing the manifold 101 or 201.

FIG. 4B shows a top view 400b of an embodiment of the filter cap 400a. The embodiment of filter 400a shown in FIG. 4B includes at least the dish 402, top protrusion 404, top surface 406, and an outlet opening 410. In other embodiments, the embodiment shown in the view 400b may not include all of the components listed and/or may include other components in addition to or instead of those listed above.

FIG. 4B shows a top view 400b of an embodiment of the filter cap 400a.

Outlet opening 410 is a through opening in the top surface 406. In at least one embodiment, the filtered fluid runs from the inner channel 288 of the filter 286, through the outlet opening 410, into an outlet channel in the outlet conduit 246.

FIG. 4C shows a bottom view 400c of an embodiment of the filter cap 400a. The embodiment of filter 400a shown in FIG. 4C includes at least the dish 402, bottom protrusion 408, and outlet opening 410. In other embodiments, the embodiment shown in the view 400c may not include all of the components listed and/or may include other components in addition to or instead of those listed above.

FIG. 4C shows a bottom view 400c of an embodiment of the filter cap 400a. The filter 286 contacts the bottom surface of the dish 402 while the inner channel 288 is connected to the outlet opening 410. The channel formed by protrusion 408 is wider than opening 410 causing the fluids to speed up as the fluids pass into opening 410, which compensates for the reduced pressure that results after the fluids passed though the filter 286, so as to help facilitate the exiting fluids to flow out of filter unit 220 in a stream. In an alternative embodiment, outlet opening 410 is the same width or wider than the channel of protrusion 408.

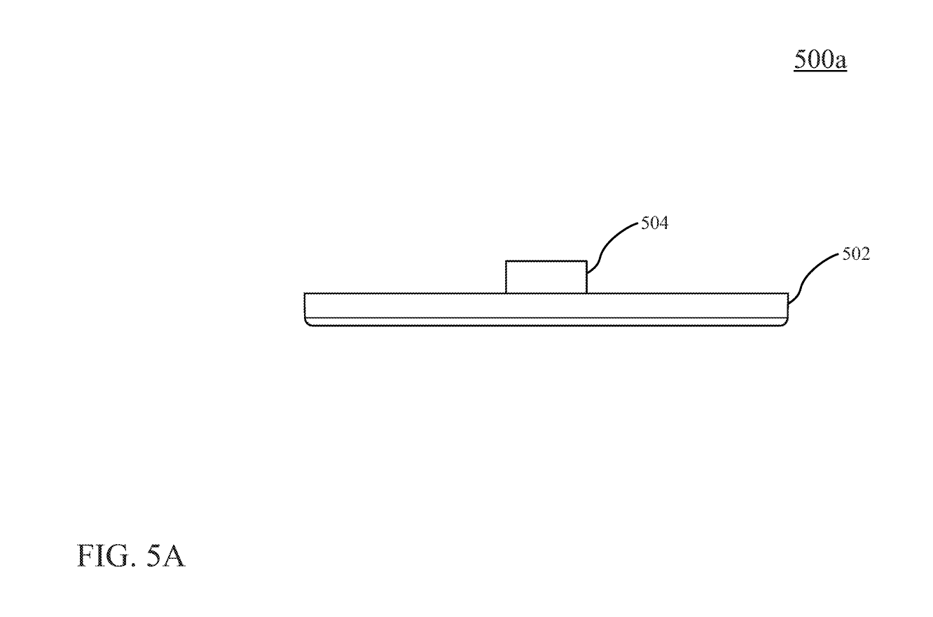

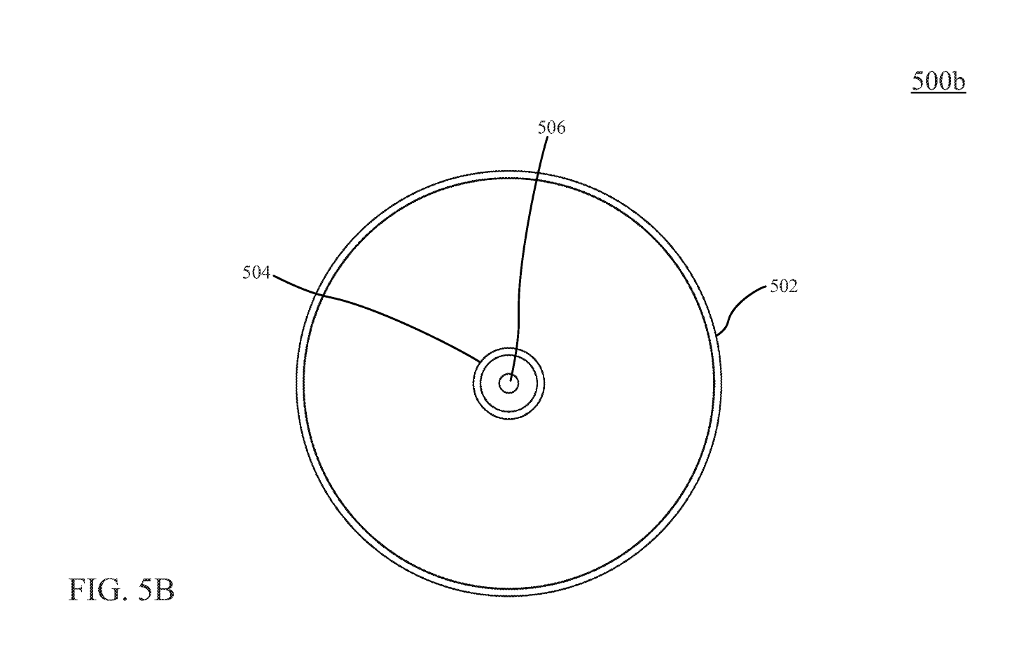

FIG. 5A shows a side view of an embodiment of the filter base 500a of the fluid filter system. Filter base 500a includes at least a dish 502 and a protrusion 504. In other embodiments, the filter base 500a may not include all of the components listed and/or may include other components in addition to or instead of those listed above.

FIG. 5A shows a side view of an embodiment of the filter base 500a. Filter base 500a may be an embodiment of the filter base 290 that was discussed in conjunction with FIG. 2.

Dish 502 is a dish shaped structure of the filter base 500a that is fitted at the bottom of the filter 286. In an embodiment, the dish 502 includes a rim having an outer edge extending upwardly for holding the filter 286 in place.

Protrusion 504 is a tubular structure that protrudes from the top side of the filter base 500a, facing the filter 286. Protrusion 504 is optional. In at least one embodiment, the protrusion 504 is fitted in the inner channel 288 of the filter 286. In an embodiment, the outer diameter of the protrusion 504 is slightly smaller than the inner diameter of the inner channel 288. Protrusion 504 may help prevent filter 286 from moving too far from side to side.

FIG. 5B shows a top view 500b of an embodiment of the filter base 500a. The embodiment of the filter base 500a shown in FIG. 5B includes at least the dish 502, protrusion 504, and a raised portion 506. In other embodiments, the embodiment shown in the view 500b may not include all of the components listed and/or may include other components in addition to or instead of those listed above.

FIG. 5B shows a top view 500b of an embodiment of the filter base 500a.

Raised portion 506 is a raised portion at the bottom surface inside the protrusion 504.

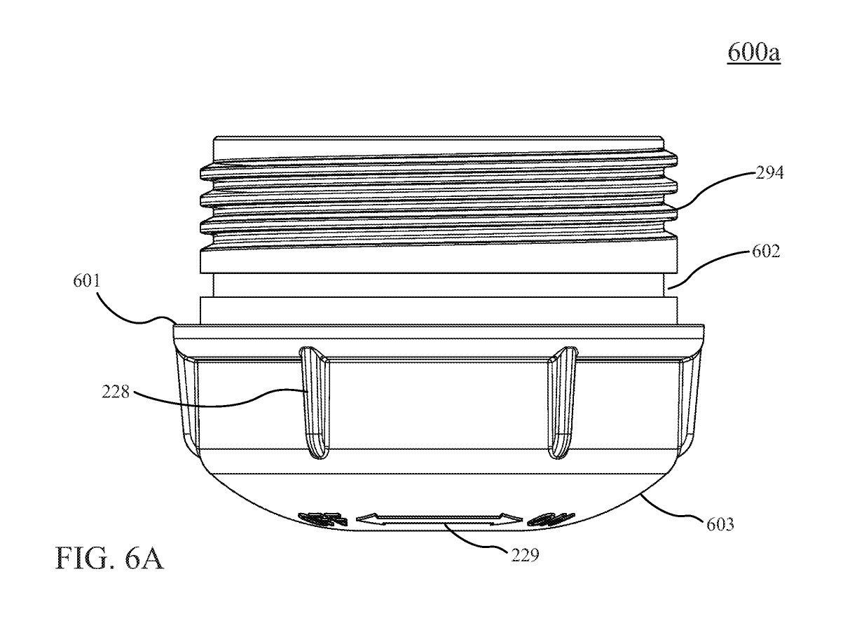

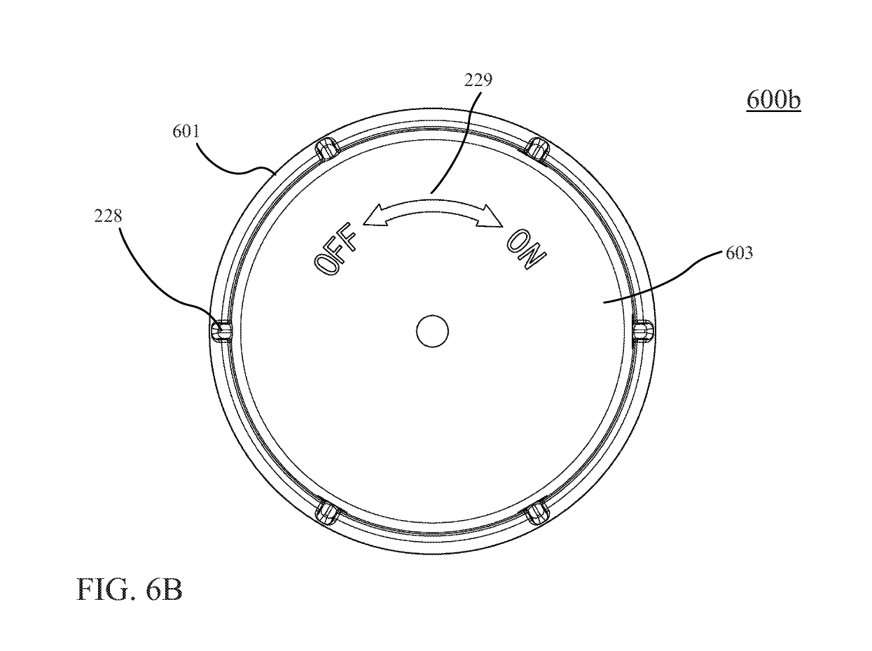

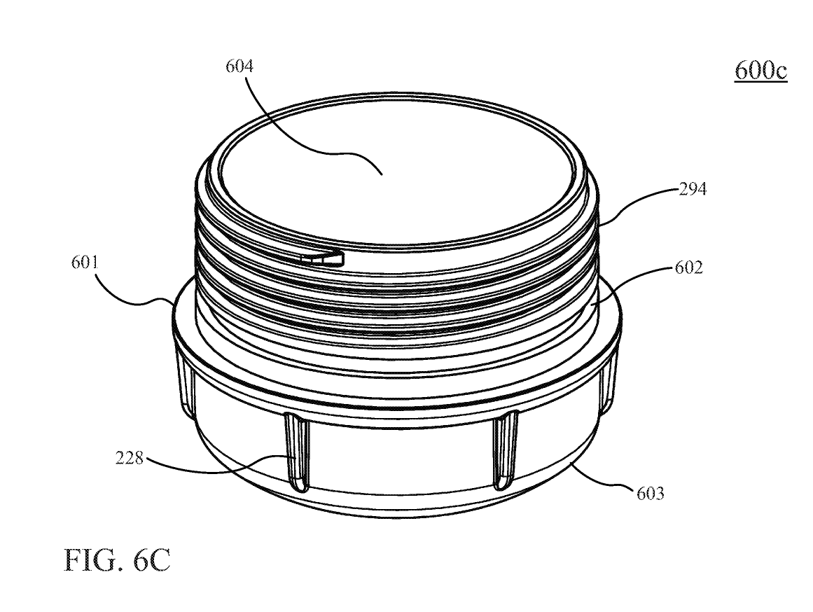

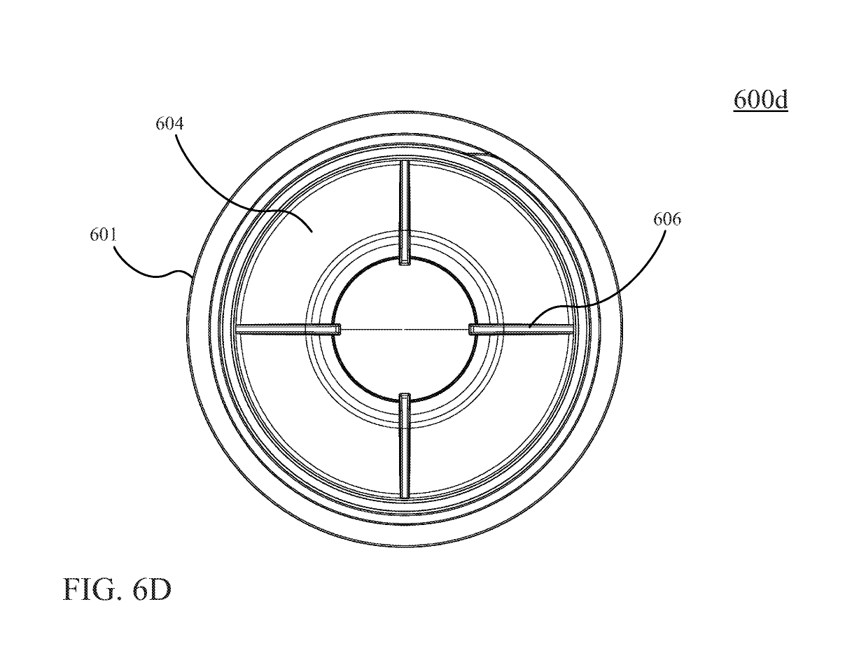

FIG. 6A shows a side view of an embodiment of the end cap 600a of the fluid filter system. End cap 600a includes at least the tabs 228, markings 229, and threads 294. The end cap 600a further includes at least a rim 601, a groove 602, and a bottom portion 603. In other embodiments, the end cap 600a may not include all of the components listed and/or may include other components in addition to or instead of those listed above.

FIG. 6A shows a side view of an embodiment of the end cap 600a. End cap 600 may be an embodiment of the end cap 126 or 226, which were discussed in conjunction with FIGS. 1A, 1B, and 2.

Rim 601 is a rim surrounding the end cap 600a and is located below a top part of the end cap 600a that has threads 294, which mate with inner threads 296 at the bottom end of the filter housing 122, 222, or 300a. In an embodiment, the outer diameter of the rim 601 is equal to or larger than the outer diameter of the filter housing.

Groove 602 is a circumferential groove formed in the top part of the end cap 226 below the threads 294. In an embodiment, the groove 602 is adapted and configured for receiving the o-ring 292 for preventing fluid from leaking between the end cap 226 and the filter housing 222. In other embodiments, o-ring 292 could be placed elsewhere, such as directly on rim 601.

Bottom portion 603 is a bottom portion of the end cap 600a that is below the rim 601. In at least one embodiment, the bottom portion 603 is not inserted into the filter housing 222. The tabs 228 protrudes from the bottom portion 603 for providing a better grip. In an embodiment, the bottom portion 603 has an outer diameter that is smaller than the rim 601.

FIG. 6B shows a bottom view 600b of an embodiment of the end cap 600a. The embodiment of end cap 600a shown in FIG. 6B includes at least the fins 228, markings 229, rim 601, and bottom portion 603. In other embodiments, the embodiment shown in the view 600b may not include all of the components listed and/or may include other components in addition to or instead of those listed above.

FIG. 6B shows a bottom view 600b of an embodiment of the end cap 600a. FIG. 6B shows markings 229 showing directions toward which the end cap 600a may be detached and connected.

FIG. 6C shows another view of an embodiment of the end cap 600a. The embodiment of end cap 600a shown in FIG. 6C includes at least the fins 228, threads 294, rim 601, groove 602, bottom portion 603, and a cavity 604. In other embodiments, the embodiment shown in the view 600c may not include all of the components listed and/or may include other components in addition to or instead of those listed above.

FIG. 6C shows another view of an embodiment of the end cap 600a.

Cavity 604 is a hollow cavity inside the end cap 600a, with an opening into which a portion of the filter 286 and the filter base 290 is fitted.

FIG. 6D shows a top view of an embodiment of the end cap 600a. The embodiment of end cap 600a shown in FIG. 6D includes at least the rim 601, cavity 604, and fins 606. In other embodiments, the embodiment shown in the view 600d may not include all of the components listed and/or may include other components in addition to or instead of those listed above.

FIG. 6D shows a top view of an embodiment of the end cap 600a.

Fins 606 are a plurality of fins that extend from the inner bottom side of the cavity 604 in the end cap 600a, facing toward the filter 286. In an embodiment, the fins 606 contact and support the filter base 290 while the filter unit 120 or 220 is fully assembled.

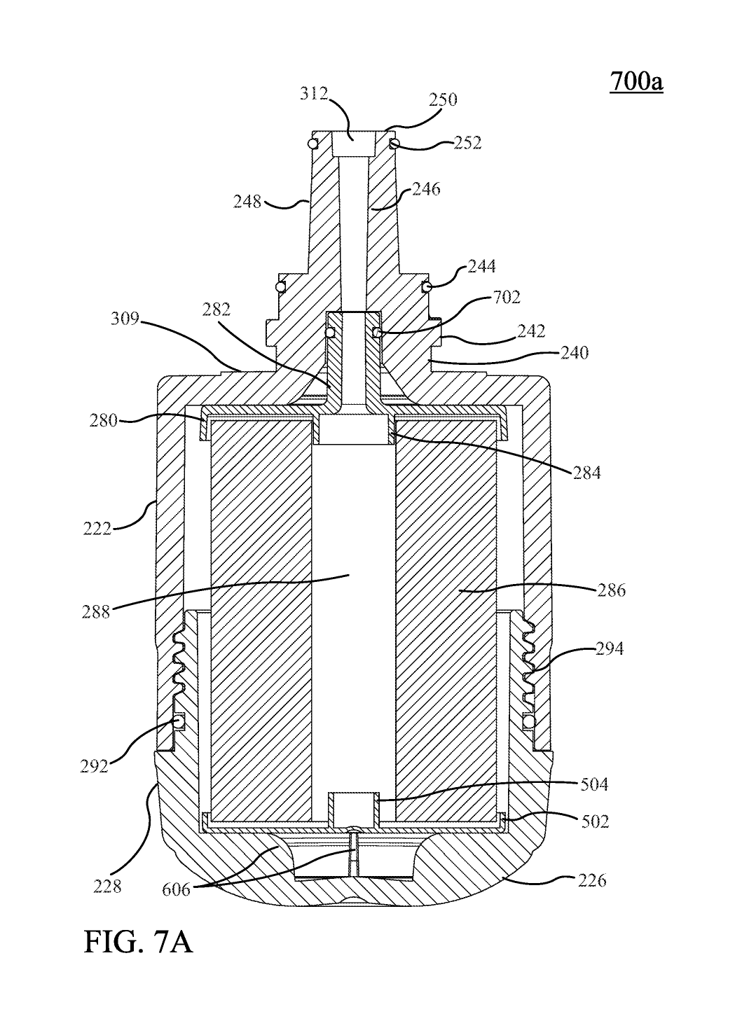

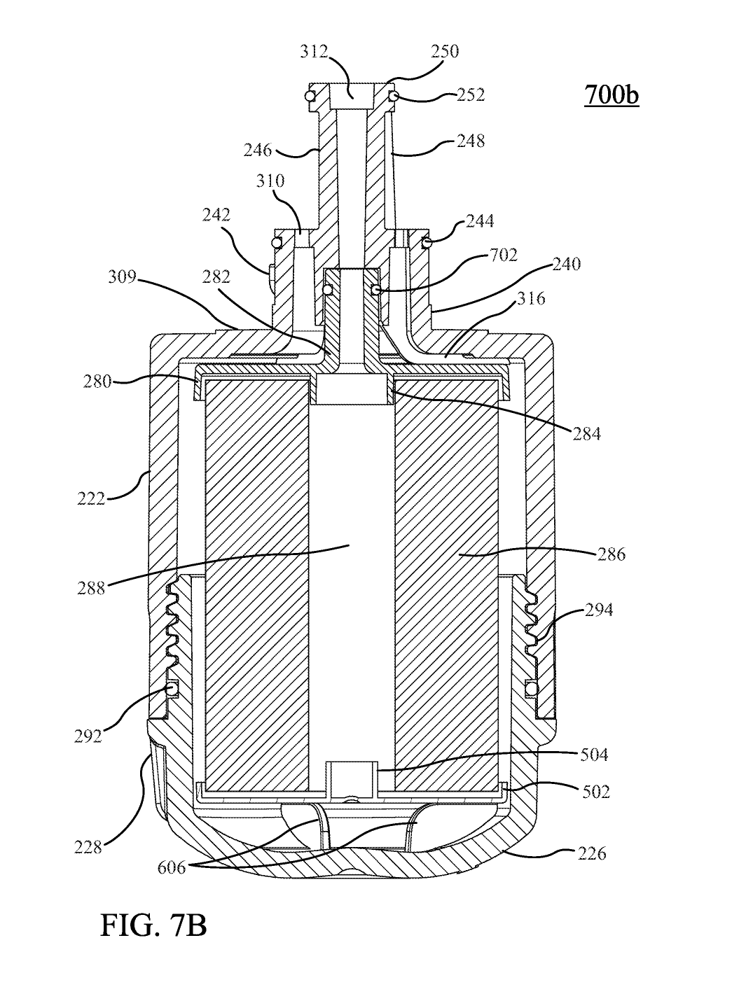

FIG. 7A shows a cross-sectional side view of an embodiment of the filter unit 700a of the fluid filter system. Filter unit 700a includes at least the filter housing 222, end cap 226, tabs 228, neck 240, tabs 242, o-ring 244, outlet conduit 246, fins 248, top member 250, o-ring 252, filter cap 280, top protrusion 282, bottom protrusion 284, filter 286, inner channel 288, o-ring 292, threads 294, bottom member 309, outlet opening 312, filter base 502, protrusion 504, and fins 606. The filter unit 700a further includes an o-ring 702. In other embodiments, the filter unit 700a may not include all of the components listed and/or may include other components in addition to or instead of those listed above.

FIG. 7A shows a cross-sectional side view of an embodiment of the filter unit 700a that encloses the filter media. In at least one embodiment, the filter 286 is securely installed between the filter cap 280 and the filter base 290, separating a space in-between the filter 286 and the filter housing 222 that receives incoming unfiltered fluid and a space in the inner channel 288 that directs filtered fluid out of the filter unit 700a. The unfiltered fluid surrounding the filter 286 passes through, in the process of being filtered by, the filter 286, and subsequently enters the inner channel 288.

O-ring 702 is an o-ring that is fitted around the top protrusion 282 of the filter cap 280 for providing a fluid-tight seal when the top protrusion 282 of the filter cap 280 is inserted in the neck 240. The seal around the top protrusion 282 prevents the outlet filtered fluid in the outlet channel in the outlet conduit 246 from leaking around the top protrusion 282. O-ring 702 is optional and may be replaced with another manner of maintaining a fluid-tight seal.

FIG. 7B shows another cross-sectional side view 700b of an embodiment of the filter unit 700a of FIG. 7A. The embodiment of filter unit 700a shown in FIG. 7B includes at least the filter housing 222, end cap 226, tabs 228, neck 240, tabs 242, o-ring 244, outlet conduit 246, fins 248, top member 250, o-ring 252, filter cap 280, top protrusion 282, bottom protrusion 284, filter 286, inner channel 288, o-ring 292, threads 294, bottom member 309, holes 310, outlet opening 312, fins 316, filter base 502, protrusion 504, fins 606, and o-ring 702. In other embodiments, the embodiment shown in the view 700b may not include all of the components listed and/or may include other components in addition to or instead of those listed above.

FIG. 7B shows another cross-sectional side view 700b. FIG. 7B shows the pair of holes 310 on the top surface of the neck 240.

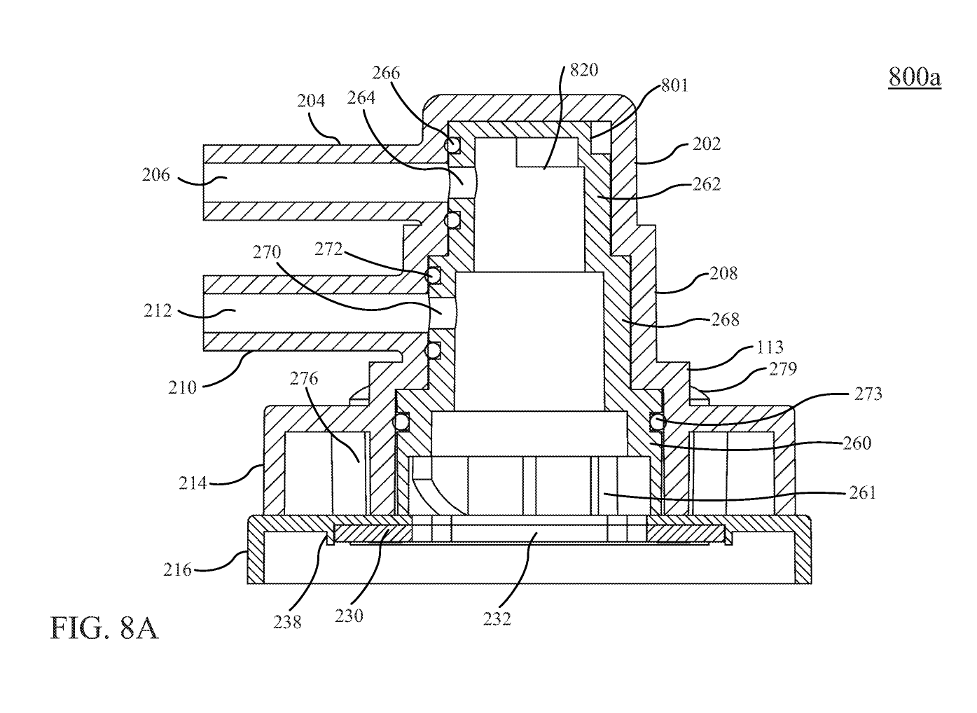

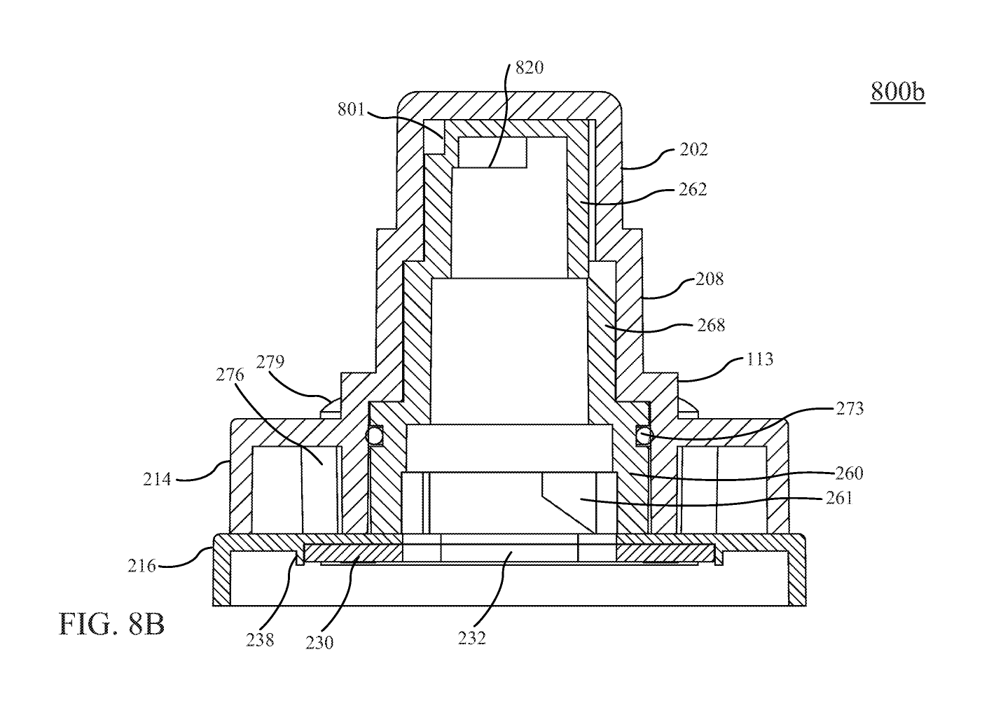

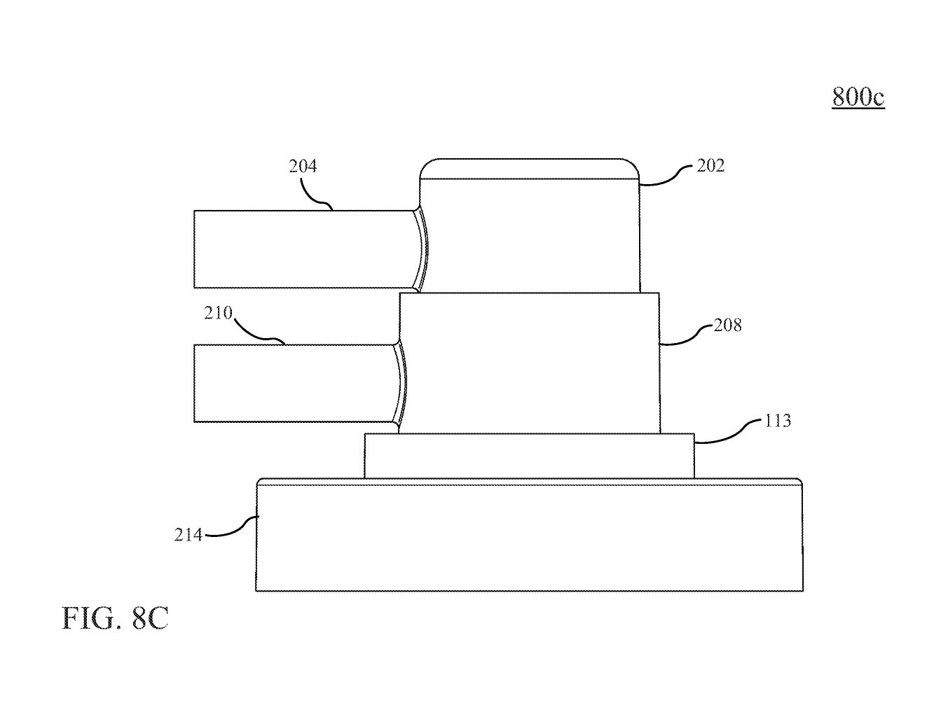

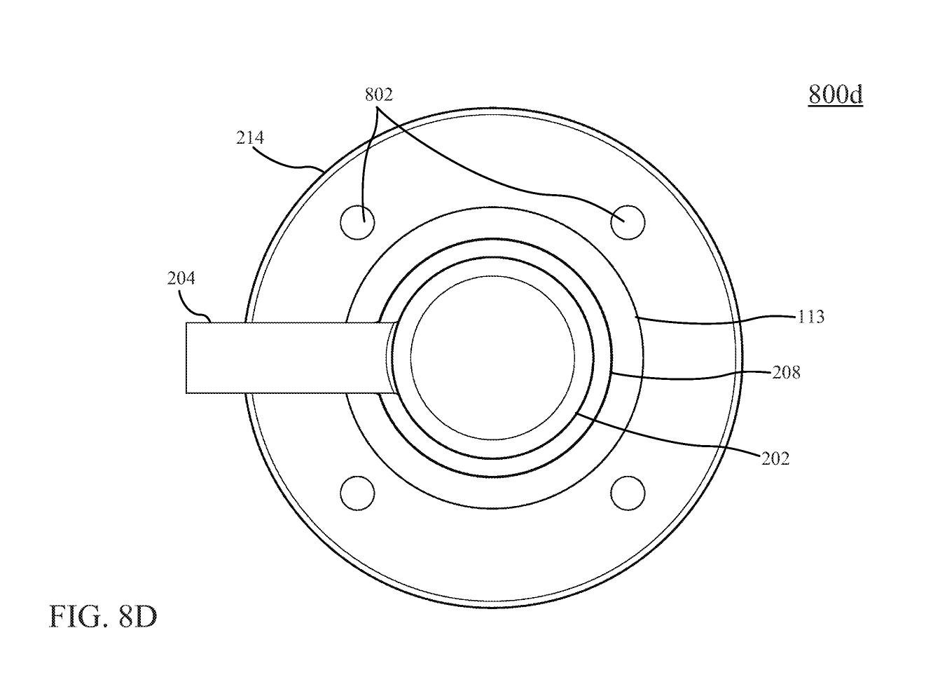

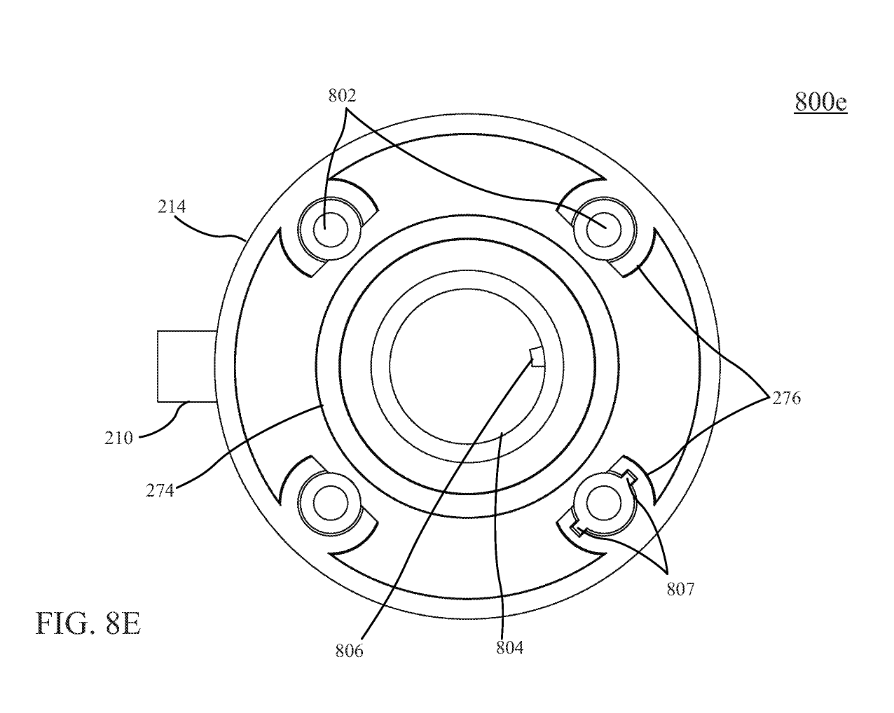

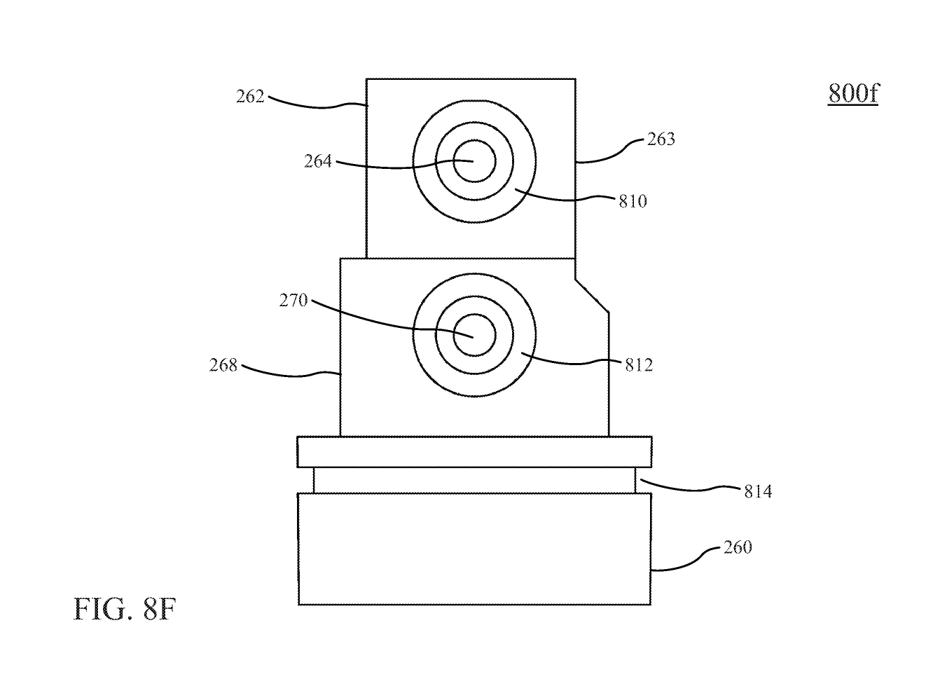

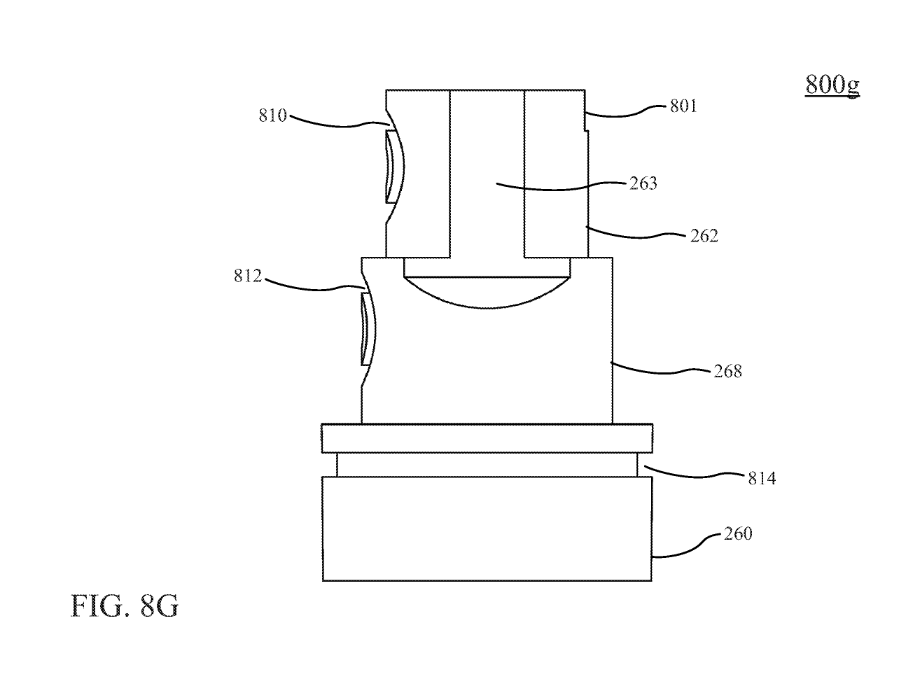

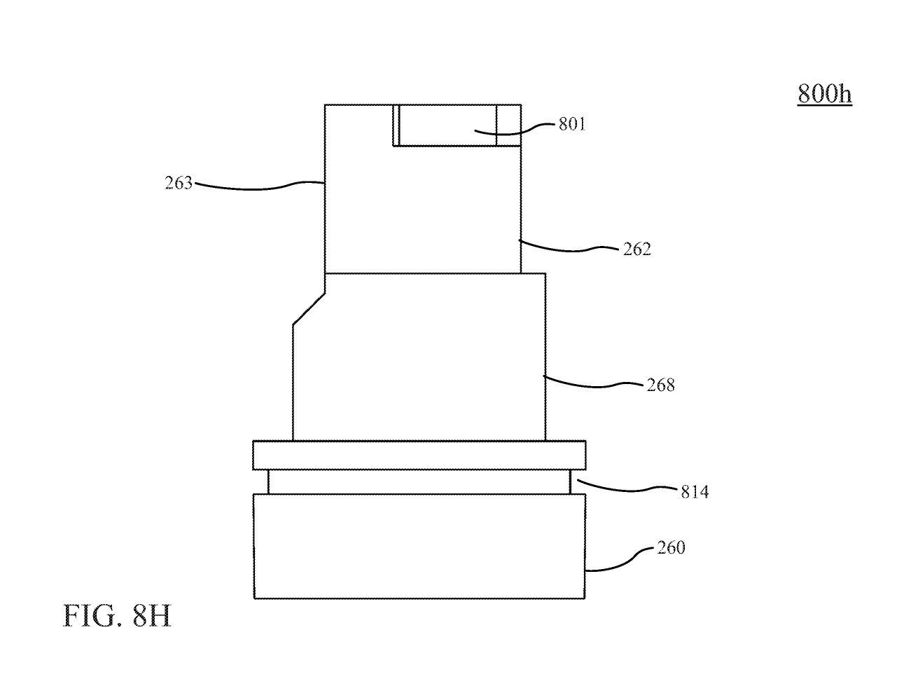

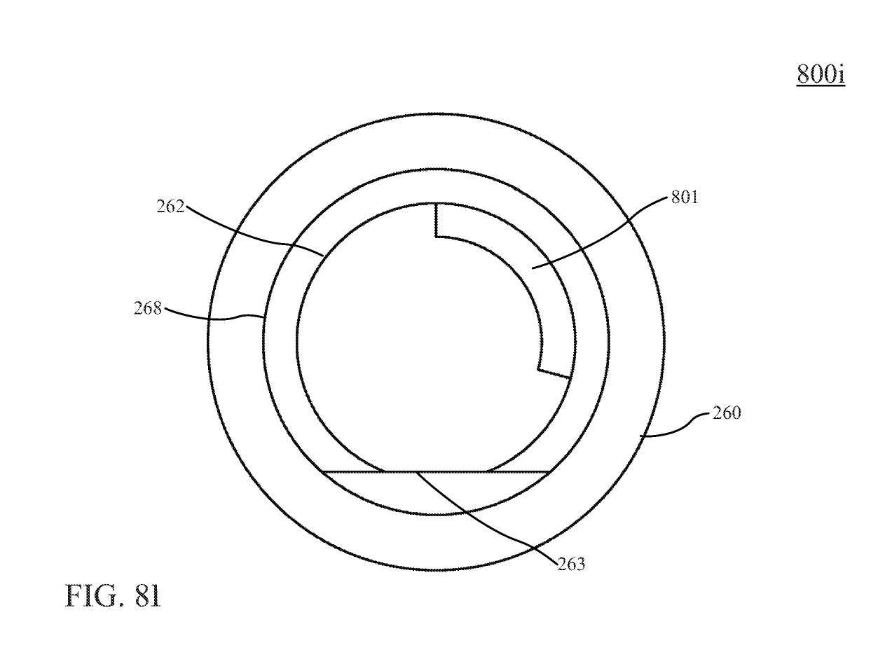

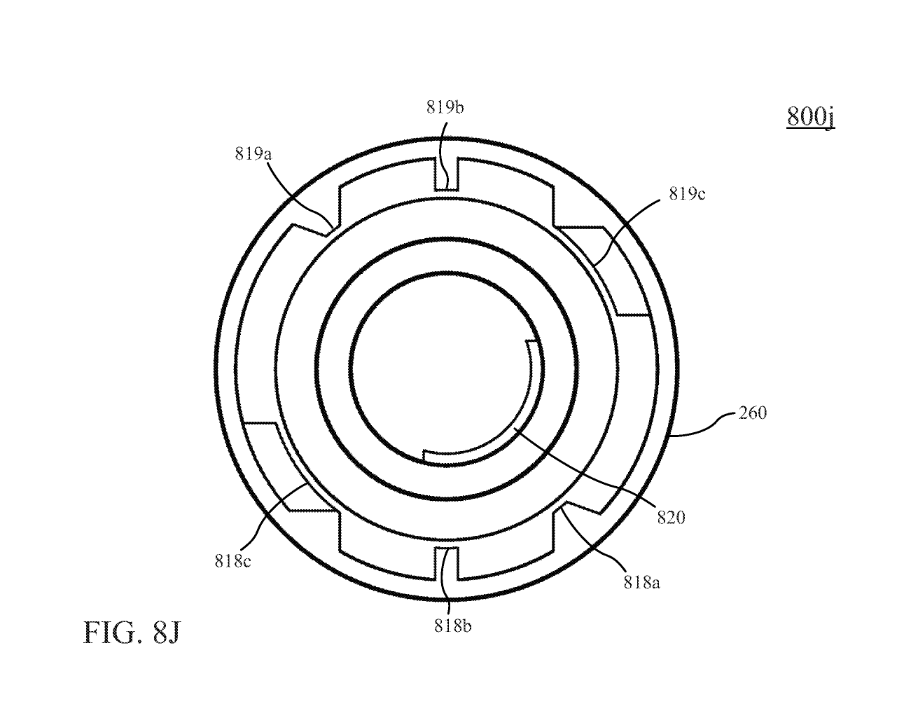

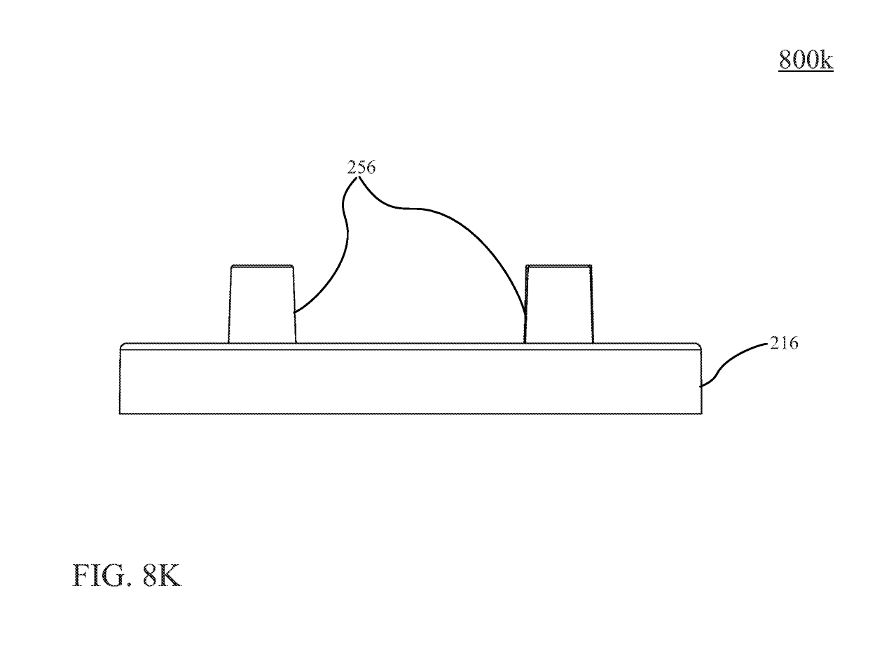

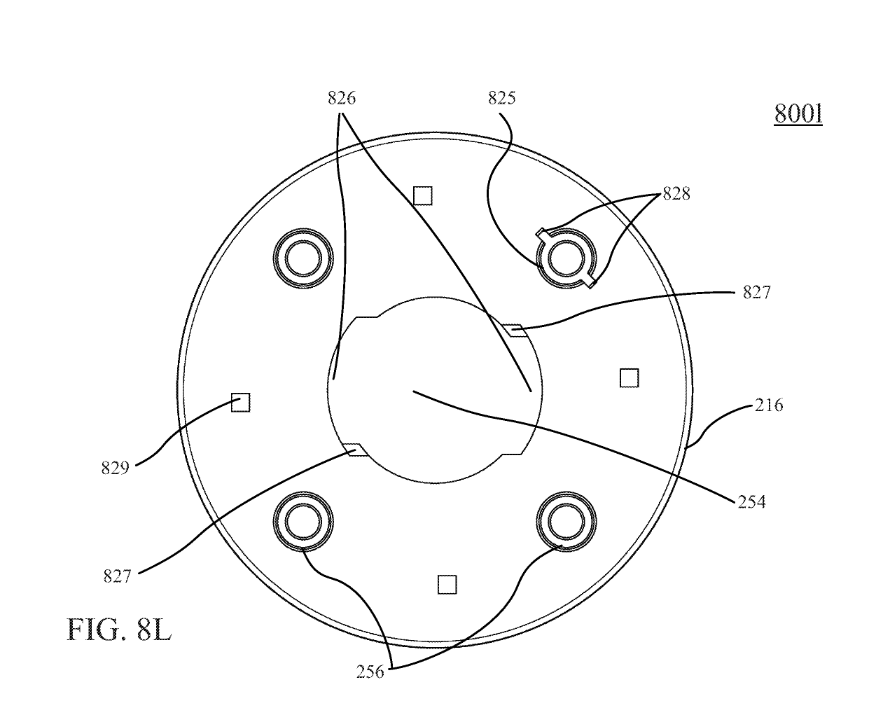

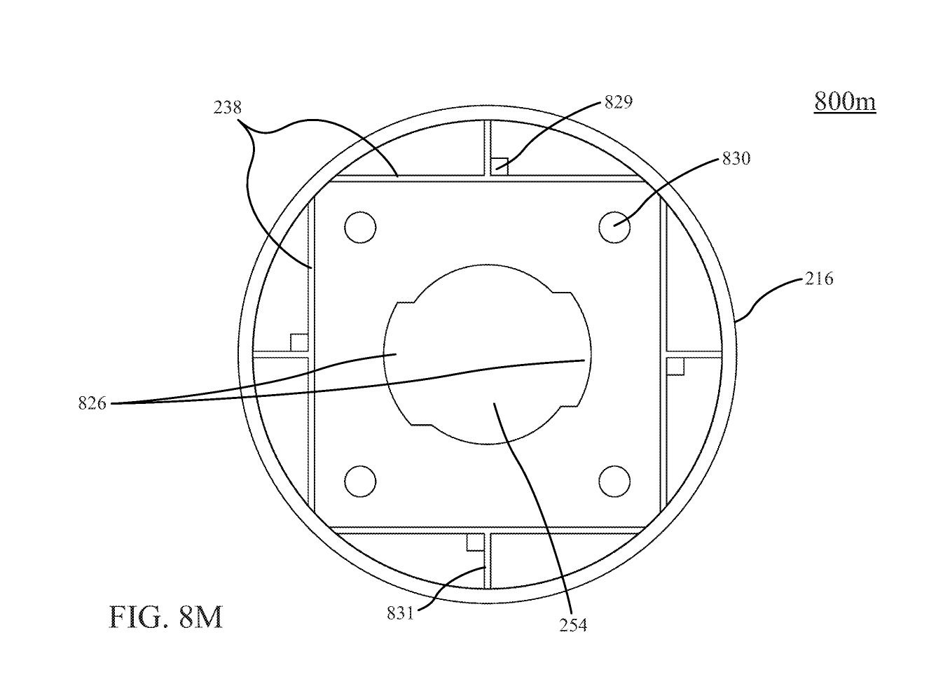

FIG. 8A shows a cross-sectional side view of an embodiment of the manifold 800a of the fluid filter system. Manifold 800a includes at least the raised portion 113, outlet portion 202, outlet port 204, outlet channel 206, inlet portion 208, inlet port 210, inlet channel 212, bottom portion 214, supporting member 216, plate 230, opening 232, tabs 238, valve base 260, tabs 261, outlet portion 262, outlet opening 264, o-ring 266, inlet portion 268, inlet opening 270, o-ring 272, o-ring 273, guide members 276, screws 279, which were discussed in FIGS. 1A, 1B, and 2, respectively. Manifold 800a further includes an indent 801 and a protrusion 820. In other embodiments, the manifold 800a may not include all of the components listed and/or may include other components in addition to or instead of those listed above.

FIG. 8A shows a cross-sectional side view of an embodiment of the manifold 800a.

Indent 801 is an indent from a top edge of the outlet portion 262 of the valve 259. In an embodiment, the indent 801 runs along a section of the peripheral (e.g., a quarter of a circle) of the top edge of the outlet portion 262. In an embodiment, one end of the indent 801 is located approximately opposite to the outlet opening 264, while the other end of the indent 801 is at an angle (e.g., 30 degrees, 40 degrees, 50 degrees, 60 degrees, 70 degrees, 80 degrees, 90 degrees, 100 degrees, 110 degrees, 120 degrees, 130 degrees, 140 degrees, 150 degrees) from the outlet opening 164. In at least one embodiment, a tab extending from inside the outlet portion 202 of the manifold housing 215 fits in the indent 801 when the manifold 800a is assembled. The indent 801 will be discussed further in FIGS. 8G, 8H, and 8I.

Protrusion 820 is a protrusion extending inwardly from the inner edge of the outlet portion 202 of the manifold housing (e.g., the underside of the indent 801).

FIG. 8B shows another cross-sectional side view 800b of an embodiment of the manifold 800a of FIG. 8A. The embodiment of manifold 800a shown in FIG. 8B includes at least the raised portion 113, outlet portion 202, inlet portion 208, bottom portion 214, supporting member 216, plate 230, opening 232, tabs 238, valve base 260, tabs 261, outlet portion 262, inlet portion 268, o-ring 273, guide members 276, screws 279, indent 801, and protrusion 820, which were discussed in FIGS. 1A, 1B, 2, and 8A. In other embodiments, the embodiment shown in the view 800b may not include all of the components listed and/or may include other components in addition to or instead of those listed above.

FIG. 8B shows another cross-sectional side view 800b that is approximately 90 degrees relative to the cross-sectional side view 800a.

FIG. 8C shows a side view of an embodiment of the manifold housing 800c.

Manifold housing 800c includes at least the raised portion 113, outlet portion 202, outlet port 204, inlet portion 208, inlet port 210, and bottom portion 214. In other embodiments, the manifold housing 800c may not include all of the components listed and/or may include other components in addition to or instead of those listed above.

FIG. 8C shows an embodiment of the manifold housing 800c. Manifold housing 800c may be an embodiment of the manifold housing 215 that was discussed in conjunction with FIG. 2.

FIG. 8D shows a top view 800d of an embodiment of the manifold housing 800c.

The embodiment of manifold housing 800c shown in FIG. 8D includes at least the raised portion 113, outlet portion 202, outlet port 204, inlet portion 208, bottom portion 214, and holes 802. In other embodiments, the embodiment shown in the view 800d may not include all of the components listed and/or may include other components in addition to or instead of those listed above.

FIG. 8D shows a top view 800d of an embodiment of the manifold housing 800c, in which the outlet port 204 is visible.

Holes 802 are a plurality of holes through which the screws 279 are inserted to fasten the manifold housing 800c with the supporting member 216.

FIG. 8E shows a bottom view 800e of an embodiment of the manifold housing 800c. The embodiment of manifold housing 800c shown in FIG. 8E includes at least the inlet port 210, bottom portion 214, bottom protrusion 274, guide members 276, holes 802, an inner surface 804, a tab 806, and recessed areas 807. In other embodiments, the embodiment shown in the view 800e may not include all of the components listed and/or may include other components in addition to or instead of those listed above.

FIG. 8E shows a bottom view 800e of an embodiment of the manifold housing 800c, in which the inlet port 210 is visible.

Inner surface 804 is an inner surface of channel, which may be tubular, of the outlet portion 202 of the manifold housing 201. In at least one embodiment, the channel of inner surface 804 includes an opening that is connected to the outlet channel 206, so that fluids can flow from the channel having inner surface 804 to outlet channel 206. In at least one embodiment, the channel of the inner surface 804 is perpendicular to outlet channel 206.

Tab 806 is a tab that extends inwardly from the inner surface 804. In an embodiment, the tab 806 is located at an opposite side as the opening that leads to the outlet channel 206. In at least one embodiment, the tab 806 fits inside the indent 801 while the manifold 800a is assembled. The valve 259 may rotate with respect to the manifold housing 215 in a range permitted by the tab 806 that may block either end of the indent 801 from rotating further.

Recessed areas 807 are recessed areas at either side of one of the holes 802 for wings on one of the posts 256 to fit in. In an embodiment, the recessed areas 807 only permits one of the posts 256 that has wings to mate with the one opening with corresponding recessed areas 807.

FIG. 8F shows a front view of an embodiment of the valve 800f. Valve 800f includes at least the valve base 260, outlet portion 262, flat portion 263, outlet opening 264, inlet portion 268, inlet opening 270, and grooves 810, 812, and 814. In other embodiments, the valve 800f may not include all of the components listed and/or may include other components in addition to or instead of those listed above.

FIG. 8F shows an embodiment of the valve 800f Valve 800f may be an embodiment of the valve 259 that was discussed in conjunction with FIG. 2.

Groove 810 is a groove surrounding the outlet opening 264, in which the o-ring 266 is fitted to prevent outlet fluid from leaking between the outlet portion 262 and the outlet portion 202 of the manifold housing 215 or 800d.

Groove 812 is a groove surrounding the inlet opening 270, in which the o-ring 272 is fitted to prevent incoming fluid from leaking between the inlet portion 268 and the inlet portion 208 of the manifold housing 215 or 800d.

Groove 814 is a groove on the valve base 260, in which the o-ring 273 is fitted to prevent fluid from leaking around the valve base 260.

FIG. 8G shows a side view 800g of an embodiment of the valve 800f. The embodiment of valve 800f shown in FIG. 8G includes at least the valve base 260, outlet portion 262, flat portion 263, inlet portion 268, indent 801, and grooves 810, 812, and 814. In other embodiments, the embodiment shown in the view 800g may not include all of the components listed and/or may include other components in addition to or instead of those listed above.

FIG. 8G shows a side view 800g of an embodiment of the valve 800f, in which the flat portion 263 is visible.

FIG. 8H shows a back view 800h of an embodiment of the valve 800f. The embodiment of valve 800f shown in FIG. 8H includes at least the valve base 260, outlet portion 262, flat portion 263, inlet portion 268, indent 801, and groove 814. In other embodiments, the embodiment shown in the view 800h may not include all of the components listed and/or may include other components in addition to or instead of those listed above.

FIG. 8H shows a back view 800h of an embodiment of the valve 800f in which the indent 801 is visible.

FIG. 8I shows a top view 800i of an embodiment of the valve 800f. The embodiment of valve 800f shown in FIG. 8I includes at least the valve base 260, outlet portion 262, flat portion 263, inlet portion 268, and indent 801. In other embodiments, the embodiment shown in the view 800i may not include all of the components listed and/or may include other components in addition to or instead of those listed above.

FIG. 8I shows a top view 800i of an embodiment of the valve 800f. FIG. 8I shows the relative location of the flat portion 263 and the indent 801. In the embodiment of the flat portion 263 being approximately 90 degrees from the outlet opening 264, the outlet opening 264 is located at the right side of the outlet portion 262, facing toward the right in FIG. 8I. One end of the indent 801 is approximately opposite the outlet opening 264, so that when the tab 806 is in contact with the end opposite the outlet opening 264, the outlet opening 264 aligns with the outlet channel 206 of the outlet port 204. When the valve 800f rotates to move so that the tab 806 is away from the end of indent 801 that is opposite the outlet opening 264, the outlet opening 264 is moved away from the outlet channel 206 and thus is blocked by the inner surface 804 of the outlet portion 202 of the manifold housing.

FIG. 8J shows a bottom view 800j of an embodiment of the valve 800f. The embodiment of valve 800f shown in FIG. 8J includes at least the valve base 260, tabs 818a, 818b, and 818c, tabs 819a, 819b, and 819c, and protrusion 820. In other embodiments, the embodiment shown in the view 800j may not include all of the components listed and/or may include other components in addition to or instead of those listed above.

FIG. 8J shows a bottom view 800j of an embodiment of the valve 800f.

Tabs 818a, 818b, and 818c and tabs 819a, 819b, and 819c may be embodiments of the tabs 261 that were discussed in conjunction with FIG. 2. In at least one embodiment, two recessed areas are formed between the tabs 818a and 818b and tabs 818b and 818c, into which the teeth 318 and 319 are fitted to engage the neck 240 on the filter housing 222 with the valve 259. In an embodiment, the tab 818c (as well as the tab 819c) includes a ramped surface. In an embodiment, the tooth 317 has a ramped surface that rides up to the ramped surface on the tab 818c so as to engage the tabs 302a and the tabs 818a, 818b, and 818c. In an embodiment, the tabs 302b engages the tabs 819a, 819b, and 819c while the tabs 302a engages the tabs 818a, 818b, and 818c. Alternatively or additionally, other types of fasteners, such as buckles, buttons, or snaps, may be used to engage the filter unit 220 with the valve 259.

FIG. 8K shows a side view 800k of an embodiment of the supporting member 216. The embodiment of supporting member 216 shown in FIG. 8K includes at least the supporting member 216 and posts 256. In other embodiments, the embodiment in the view 800k may not include all of the components listed and/or may include other components in addition to or instead of those listed above.

FIG. 8K shows a side view 800k of an embodiment of the supporting member 216, in which two of the posts 256 are visible.

FIG. 8L shows a top view 800l of an embodiment of the supporting member 216. The embodiment of supporting member 216 shown in FIG. 8L includes at least the supporting member 216, opening 254, posts 256, which were discussed in FIG. 2. The embodiment of supporting member 216 shown in FIG. 8L further includes a post 825, notches 826, ramps 827, wings 828, and holes 829. In other embodiments, the embodiment shown in the view 800l may not include all of the components listed and/or may include other components in addition to or instead of those listed above.

FIG. 8L shows a top view 800l of an embodiment of the supporting member 216. In an embodiment, the supporting member 216 includes four posts 256 that are equal angularly spaced. The four posts 256 may be similar or different from one another. In an embodiment, one of the posts 256 on the supporting member 216 includes two wings while the other three posts do not include wings.

Post 825 may be an embodiment of one of the four posts 256 while the post 825 includes two wings. Post 825 fits into one of the guide members 276 that has corresponding recessed areas 807 (FIG. 8E) when the manifold is assembled.

Notches 826 are two notches at either side of the opening 254, facing each other. In at least one embodiment, the notches 826 allow the tabs 142 or 242, or tabs 302a and 302b, to be inserted through.

Ramps 827 are two ramps on an end of the notches 826, facing one another. In an embodiment, the ramps 827 guide the tabs 142 or 242, or tabs 302a and 302b to ride up on the supporting member 216.

Wings 828 are two wings that connect to the post 825. When the manifold housing 222 is mounted on the supporting member 216, the wings 828 of the post 825 fit into the two corresponding recessed areas 807 of one of the guide members 276 (FIG. 8E). In other embodiments, there may be a different number of wings (e.g., there may be two wings, three wings, five wings, six wings, seven wings, or eight wings, for example) and corresponding recessed areas.

Holes 829 are a plurality of holes in the supporting member 216.

FIG. 8M shows a bottom view 800m of an embodiment of the supporting member 216. The embodiment of supporting member 216 shown in FIG. 8M includes at least the supporting member 216, tabs 238, opening 254, notches 826, holes 829, holes 830, and arms 831. In other embodiments, the embodiment shown in the view 800m may not include all of the components listed and/or may include other components in addition to or instead of those listed above.

FIG. 8M shows a bottom view 800m of an embodiment of the supporting member 216.

Holes 830 are four holes through which the screws 279 are inserted.

Arms 831 are a plurality of arms, providing structural support to and, extending outwardly from the tabs 238, and arms 831 connect to the edge of the supporting member 216. In an embodiment, arms 831 are perpendicular to the tabs 238 and supports the tabs 238. Arms 831 are optional. In an embodiment, the holes 829 are at a location where the arms 831 meet the tabs 238.

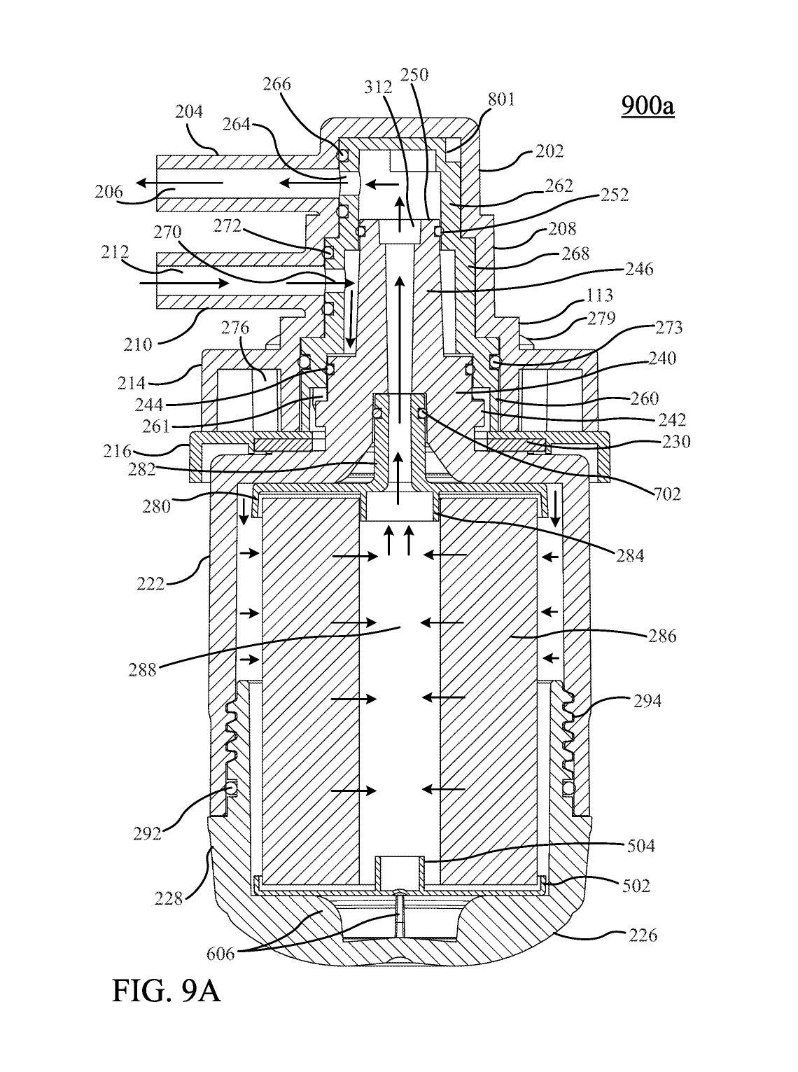

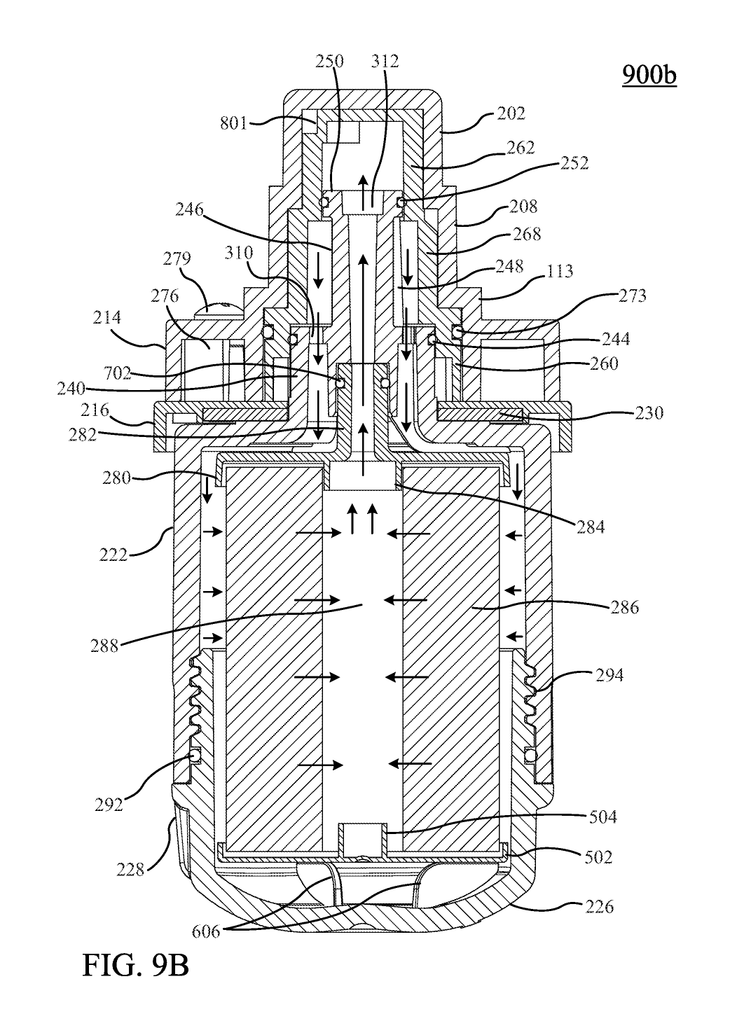

FIG. 9A shows a cross-sectional side view of an embodiment of the fluid filter system 900a. Fluid filter system 900a includes at least the raised portion 113, outlet portion 202, outlet port 204, outlet channel 206, inlet portion 208, inlet port 210, inlet channel 212, bottom portion 214, supporting member 216, filter housing 222, end cap 226, tabs 228, plate 230, neck 240, tabs 242, o-ring 244, outlet conduit 246, top member 250, o-ring 252, valve base 260, tabs 261, outlet portion 262, outlet opening 264, o-ring 266, inlet portion 268, inlet opening 270, o-ring 272, o-ring 273, guide members 276, screws 279, filter cap 280, top protrusion 282, bottom protrusion 284, filter 286, inner channel 288, o-ring 292, threads 294, outlet opening 312, filter base 502, protrusion 504, fins 606, o-ring 702, and indent 801. In other embodiments, the fluid filter system 900a may not include all of the components listed and/or may include other components in addition to or instead of those listed above.

FIG. 9A shows a cross-sectional side view of an embodiment of the fluid filter system 900a that includes the manifold 101, 201, or 800a (FIGS. 1A-1B, 2, and 8A-8B, respectively) and the filter unit 120, 220, or 700a (FIGS. 1A-1B, 2, and 7A-7B, respectively). FIG. 9A, as well as FIG. 9B, includes arrows that indicate the directions of fluid flow within the fluid filter system 900a. In contrast to FIGS. 7A and 7B, where a cross section of the filter unit was shown without the manifold attached, in FIGS. 9A and 9B, the manifold is attached. As filter unit 700a is rotated into the manifold 800a, manifold 800a engages the filter unit 700a, and the tabs 242 on the neck 240 engages the tabs 261 inside the valve base 260. When the filter unit 700a is rotated with respect to the manifold 800a, the inlet opening 270 and outlet opening 264 of the valve 259 align with the inlet channel 212 and outlet channel 206 of the manifold housing 215, which in-turn opens an incoming flow path from the inlet channel 212 via the valve 259 into the filter unit 700a and an outlet flow path from the filter unit 700a via the valve 259 and out of the outlet channel 206. In at least one embodiment, the unfiltered fluid runs via the inlet channel 212 through the inlet opening 270 into the valve 259. The unfiltered fluid then passes between the fins 248 and through the holes 310 (FIGS. 3B and 3C), and then into the space inside the filter housing 222 surrounding the filter 286. The unfiltered fluid is distributed to the outside surface of the filter 286 so that the entire cross section of the filter 286 is used in the filtering process. The fluid is filtered as the fluid passes through the filter 286, and the filtered fluid is collected in the inner channel 288 and is then directed through the outlet opening 312 of the outlet conduit 246 to the outlet opening 264 of the valve 259, through the outlet channel 206 and out of the outlet port 204.

FIG. 9B shows another cross-sectional side view 900b of an embodiment of the fluid filter system 900a of FIG. 9A. The embodiment of fluid filter system 900a shown in FIG. 9B includes at least the raised portion 113, outlet portion 202, inlet portion 208, bottom portion 214, supporting member 216, filter housing 222, end cap 226, tabs 228, plate 230, neck 240, o-ring 244, outlet conduit 246, fins 248, top member 250, o-ring 252, valve base 260, outlet portion 262, inlet portion 268, o-ring 273, guide members 276, screws 279, filter cap 280, top protrusion 282, bottom protrusion 284, filter 286, inner channel 288, o-ring 292, threads 294, holes 310, outlet opening 312, filter base 502, protrusion 504, fins 606, o-ring 702, and indent 801. In other embodiments, the embodiment shown in the view 900b may not include all of the components listed and/or may include other components in addition to or instead of those listed above.

FIG. 9B shows another cross-sectional side view 900b. FIG. 9B shows the pair of holes 310 on the top of the neck 240, through which incoming fluid enters the filter unit 700a. As mentioned above in conjunction with FIG. 9A, in contrast to FIGS. 7A and 7B, where a cross section of the filter unit 700a was shown without the manifold attached, in the cross section of FIGS. 9A and 9B, the manifold is attached.

### Method of Use

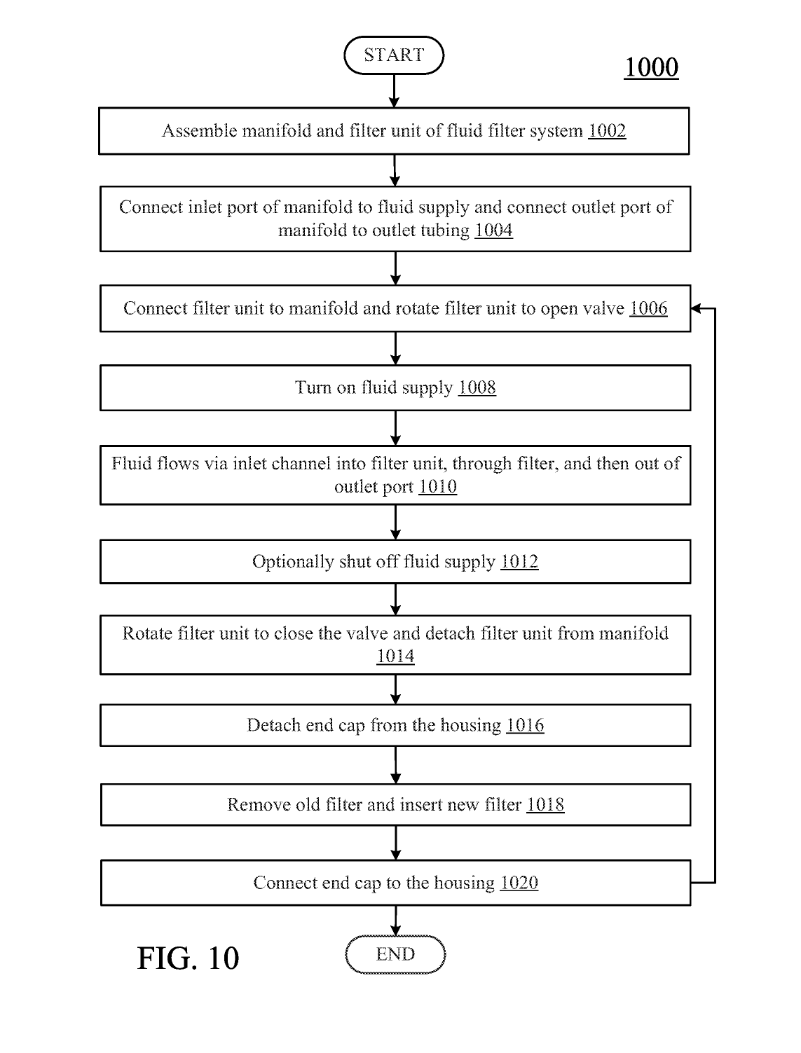

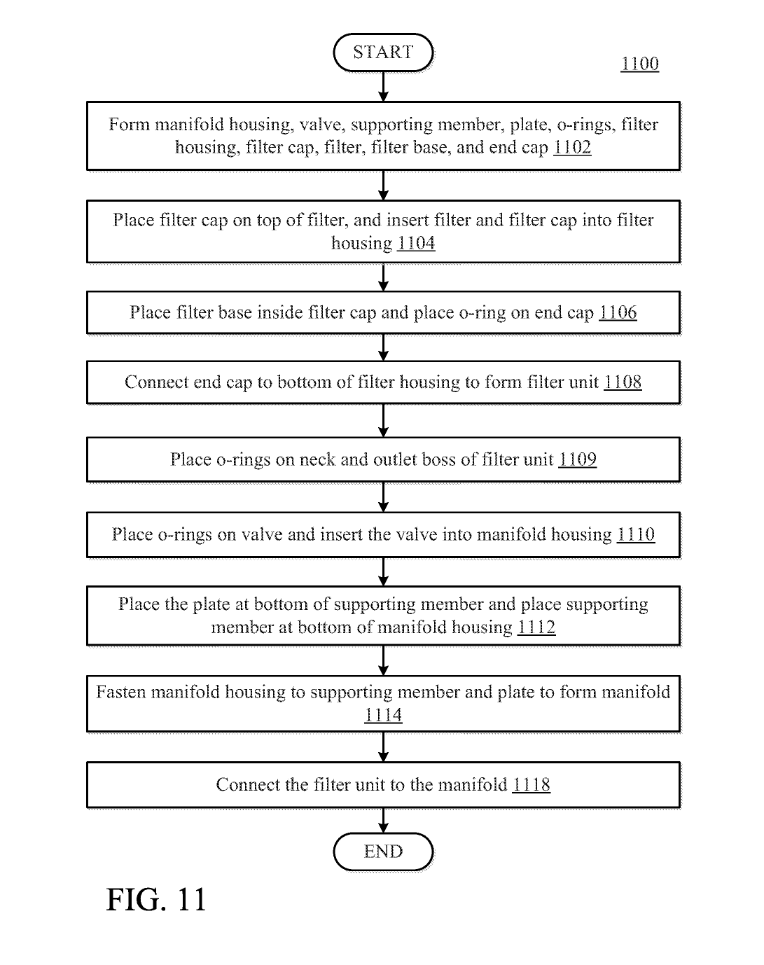

FIG. 10 is a flowchart of an embodiment of a method 1000 of using the fluid filter system. The fluid filter system mentioned in FIGS. 10 and 11 may be any of the embodiments of the fluid filter systems 100a, 100b, 200, 900a and 900b in this specification.

In step 1002, the manifold 201 and the filter unit 220 of the fluid filter system 200 are assembled.

In step 1004, the inlet port 210 is connected to the fluid supply and the outlet port 204 is connected to the outlet tubing.

In step 1006, the filter unit 220 is connected to the manifold 201. As part of the step 1006, the filter unit is rotated to open the valve 259, so as to open the flow paths between the manifold 201 and the filter unit 220.

In step 1008, the fluid supply is turned on.

In step 1010, the fluid flows via the inlet channel 212 of the manifold housing 215 into the inlet opening 270 of the valve 259, and then through the holes 310 on the neck 240 and into the space outside the filter 286 in the filter unit 220, next passing through the filter 286, and then into the inner channel 288 and then to the channel in the outlet conduit 246, and through the outlet opening 264 of the valve 259 into the outlet channel 206, and subsequently out of the outlet port 204.

In optional step 1012, the fluid supply is shut off. In at least one embodiment, in the following step while the filter unit 220 is rotated, the valve 259 is closed (by rotating the inlet opening 270 and outlet opening 264 of the valve 259 away from the inlet channel 212 and outlet channel 206 of the manifold housing 215) and thereby prevents fluid from leaking through the inlet opening 270, even if the fluid supply is kept on. Thus, it is not required to turn off the fluid supply to change the filter 286.

In step 1014, the filter unit 220 is rotated to close the valve 259. Optionally, as part of the step 1014, the filter unit 220 is detached from the manifold 201. In an embodiment, the filter unit 220 does not need to be detached from the manifold 201 to replace the filter media. For example, the filter unit 220 may be rotated to place the valve 259 in a closed position (e.g., when the inlet opening 270 and outlet opening 264 of the valve 259 do not align with the inlet channel 212 and outlet channel 206 of the manifold housing 215), and then the end cap may be detached from the filter housing to replace the filter media.

In step 1016, the end cap 226 of the filter unit 220 is detached from the filter housing 222. Optionally as part of the step 1016, the filter base 290 is also removed. In an embodiment, the filter base 290 is optional and part of the end cap 226 may serve as the base for supporting the filter.

In step 1018, the old/used filter 286 is removed from the filter housing 222 and a new filter is inserted into the filter housing 222 in place of the old filter. The optional filter base 290 may be placed at the bottom of the new filter before the end cap 226 is attached.

In step 1020, the end cap 226 is connected to the filter housing 222. In at least one embodiment, after the step 1020, the method 1000 may proceed to the step 1006 to start filtering the fluid using the new filter. In at least one embodiment, steps 1012 to 1020 are used to replace the filter and/or for maintenance, and may be performed when necessary (e.g., at a certain frequency, such as every few days, weeks, months, or years). Alternatively, the steps 1016-1020 may be replaced by one step in which a new filter unit/filter cartridge is connected to the manifold. For example, after changing the filter multiple times, while still reusing the same filter unit, it may be desirable to replace the filter unit also.

In an embodiment, each of the steps of method 1000 is a distinct step. In another embodiment, although depicted as distinct steps in FIG. 10, steps 1002-1020 may not be distinct steps. In other embodiments, method 1000 may not have all of the above steps and/or may have other steps in addition to or instead of those listed above. The steps of method 1000 may be performed in another order. Subsets of the steps listed above as part of method 1000 may be used to form their own method.

### Method of Assembly

FIG. 11 is a flowchart of an embodiment of a method 1100 of making the fluid filter system.

In step 1102, the manifold housing 215 or 800c, valve 259 or 800f, supporting member 116 or 216, plate 230, o-rings 273, 266, 272, 244, 252, 292, and 702, filter housing 122, 222, or 300a, filter cap 280 or 400a, filter 286, filter base 290 or 500a, and end cap 226 or 600a are formed.

In step 1104, the filter cap 280 is placed on top of the filter 286 and the filter 280 with the filter cap 280 is inserted into filter housing 222, with the top protrusion 282 of the filter cap 280 inserted inside the neck 240 on top of the filter housing 222. As part of step 1104, o-ring 702 is placed on the top protrusion 282, before the filter cap 280 is inserted in the filter housing 222.

In step 1106, the filter base 290 is placed inside the end cap 226 and the o-ring 292 is placed on the end cap 226.

In step 1108, the end cap 226 is connected to the bottom of the filter housing 222 to form the filter unit 220.

In step 1109, the o-ring 244 is placed on the neck on the top of the filter housing 222 and the o-ring 252 is placed on the top member of the outlet conduit 246.

In step 1110, o-rings (e.g., 266, 272, and 273) are placed on the valve 259, and the valve 259 is inserted into the manifold housing 215.

In step 1112, the plate 230 is placed at bottom of base 216 and the base 216 is placed at the bottom of manifold housing 215.

In step 1114, the manifold housing 215 is fastened to the base 216 and plate 230 using screws 279 or other fasteners to form the manifold 215.

In step 1118, the filter unit 220 is connected to the manifold 201 with the outlet conduit 246 and neck 240 inserted in the valve 259. As part of the step 1118, the tabs 242 engage the tabs 261 in the valve base 260. In an embodiment, the step 1118 is performed after the manifold 201 is connected to the fluid supply and outlet tubing.

The construction of the filter unit, steps 1104-1109, and the construction of the manifold, steps 1110-1114, could be performed in any order and/or in parallel within one another.

In an embodiment, each of the steps of method 1100 is a distinct step. In another embodiment, although depicted as distinct steps in FIG. 11, steps 1102-1118 may not be distinct steps. In other embodiments, method 1100 may not have all of the above steps and/or may have other steps in addition to or instead of those listed above. The steps of method 1100 may be performed in another order. Subsets of the steps listed above as part of method 1100 may be used to form their own method.

### ALTERNATIVES AND EXTENSIONS

In an alternative embodiment, instead of there being just two tabs, such as tabs 142, tabs 242, and tabs 302a and 302b, there may be another number of tabs, and the tabs may be different lengths and/or shapes other than the lengths/shapes depicted in the FIGS. 1A-9B. In an alternative embodiment, instead of just three teeth 317, 318, and 319, there may be another number of teeth (e.g., one, two, four, five, six, seven, or eight) or the teeth on the tabs 302a/302b may be replaced with individual tabs. However, the location, length, and/or number of tabs 142, tabs 242, and tabs 302a and 302b, and number, length and/or location of the teeth 317, 318, and 319, should be chosen to such that once the filter unit is attached to the manifold, the tabs 142, tabs 242, and tabs 302a and 302b securely mate with corresponding structures on the valve so that the filter unit rotates together with the valve. In an alternative embodiment, tabs 142, tabs 242, tabs 302a and 302b, threads 294, and/or threads 296 could be replaced with other types of fasteners, such as buckles, buttons, or snaps. In another embodiment, the valve 259 may be opened and closed manually by the user. For example, just prior to removing the filter unit/filter cartridge and/or just prior to removing the filter from within in the filter unit/filter cartridge while the filter cartridge is still attached to the manifold, the user may push a switch that rotates and closes the valve, and just after installing the filter cartridge and filter the user may push a switch that opens the valve.

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A filter system comprising:
a housing of a filter unit that has a first end and a second end, the housing including an outlet conduit on the first end and an opening on the second end, the outlet conduit extending from the first end and facing away from the opening on the second end, the first end of the housing including one or more fasteners for detachably engaging the housing with a manifold, the opening on the second end being closed by a removable cap;
a removable filter for filtering fluid, the removable filter being enclosed in the filter unit; and
the removable cap that includes at least a fastener for attaching the removable cap to the opening on the second end of the housing;
wherein the removable cap is detachable from the opening on the second end of the housing for replacing the removable filter in the filter unit.

2. The filter system of claim 1, further comprising:
a neck that extends from the housing and surrounding the outlet conduit, the neck including a plurality of holes for directing fluid into the filter unit, the outlet conduit including an outlet channel.

3. The filter system of claim 2, the one or more fasteners extending radially outwardly from the neck.

4. The filter system of claim 2, the manifold including a valve, the one or more fasteners including one or more teeth that mate with one or more recessed areas in the valve.

5. The filter system of claim 2, the filter unit further including a first space and a second space that are separated by the removable filter, the first space is on one side of a wall of the removable filter and the second space is on a second side of the wall of the removable filter;
wherein the plurality of holes in the surface of the neck is connected to the first space in the filter unit and the outlet channel in the outlet conduit is connected to the second space in the filter unit.

6. The filter system of claim 5, the first space being outside of the removable filter and the second space being inside the removable filter.

7. The filter system of claim 1, further comprising:
an o-ring that seals the removable cap that closes the opening on the second end of the housing.

8. The filter system of claim 1, further comprising:
a filter cap that is attached to one end of the removable filter, the filter cap including a through channel that has a first end and a second end, the first end of the through channel being inserted in the outlet channel of the outlet conduit, the second end of the through channel being connected to an opening in the removable filter.

9. The filter system of claim 8, wherein the first end of the through channel including an o-ring that seals the first end of the through channel and the outlet channel of the outlet conduit.

10. The filter system of claim 1, the removable cap further comprising:
a plurality of tabs extending from a peripheral of the removable cap for providing grip.

11. The filter system of claim 1, the removable cap further including screw threads that mate with screw threads at the opening on the second end of the housing for connecting the removable cap to the housing.

12. The filter system of claim 1, further comprising:
the manifold that includes at least one inlet channel for receiving fluid and one outlet channel for directing fluid out of the manifold, the manifold including a cavity inside the manifold that encloses a valve; and
the valve having an open end, an inlet opening and an outlet opening, the valve being rotatably disposed within the cavity of the manifold;
wherein when the valve is rotated to an open position, the inlet opening and the outlet opening of the valve align with the inlet channel and the outlet channel of the manifold, respectively.

13. The filter system of claim 12, the valve further comprising:
one or more fasteners inside the valve that mate with the one or more fasteners on the first end of the housing for engaging the filter unit with the valve.

14. The filter system of claim 12, the manifold further comprising:
a manifold housing that is securely fastened to a supporting member, the cavity being between the manifold housing and the supporting member; and
the supporting member including an opening through which the outlet conduit is inserted.

15. The filter system of claim 1, further comprising:
one or more o-rings for sealing the outlet conduit in the manifold.

16. A replaceable filter element for a reusable filter system, comprising:
a filter cap that is attached to one end of a removable filter media, the filter cap including at least an outlet conduit that connects with an outlet channel in a housing of a reusable filter system for directing fluid away from the removable filter media, the outlet conduit of the filter cap has a seal between the outlet conduit and the outlet channel to prevent fluid traveling from the outlet conduit to the outlet channel from leaking.

17. The replaceable filter element of claim 16, further comprising the removable filter media.

18. A method of using a filter system, the method comprising:
detaching a filter unit of the filter system from a manifold, the filter unit including at least
a housing that has a first end and a second end, the housing including an outlet conduit on the first end and an opening on the second end, the outlet conduit extending from the first end and facing away from the opening on the second end, the first end of the housing including one or more fasteners for detachably engaging the housing with the manifold, the opening on the second end being closed by a removable cap;
a removable filter for filtering fluid, the removable filter being enclosed in the filter unit; and
the removable cap that includes at least a fastener for attaching the removable cap to the opening on the second end of the housing, wherein the removable cap is detachable from the opening on the second end of the housing for replacing the removable filter in the filter unit;
detaching the removable cap from the opening on the second end of the housing;
removing the removable filter from the housing and inserting a new filter into the housing;
attaching the removable cap to the opening on the second end of the housing to seal the opening; and
attaching the filter unit to the manifold.

19. A method of assembling a filter unit of a filter system, comprising:
forming a housing of the filter unit that has a first end and a second end, the housing including an outlet conduit on the first end and an opening on the second end, the outlet conduit extending from the first end and facing away from the opening on the second end, the first end of the housing including one or more fasteners for detachably engaging the housing with a manifold, the opening on the second end of the housing including at least one fastener for detachably engaging a removable cap; and
installing a filter, through the opening on the second end of the housing, in the housing.

20. The method of claim 19, further comprising:
connecting the removable cap to the opening on the second end of the housing and sealing the opening, wherein the removable cap is detachable from the opening on the second end of the housing for replacing the filter in the filter unit.
